(19) United States
(12) Patent Application Publication
(10) Pub. No.: US 2024/0345712 A1
(43) Pub. Date: Oct. 17, 2024

(54) METHOD AND SYSTEM FOR SUMMONING ADAPTIVE TOOLBAR ITEMS AND DIGITAL ASSETS ASSOCIATED THEREWITH ON A LARGE FORMAT SCREEN WITHIN A DIGITAL COLLABORATION ENVIRONMENT

(71) Applicant: Haworth, Inc., Holland, MI (US)

(72) Inventors: Bruce HALLIDAY, Vancouver (CA); Ronald Friedrich PFEIFLE, Waterloo (CA); Rupen CHANDA, Austin, TX (US)

(73) Assignee: Haworth, Inc., Holland, MI (US)

(21) Appl. No.: 18/636,125

(22) Filed: Apr. 15, 2024

Related U.S. Application Data
(60) Provisional application No. 63/459,223, filed on Apr. 13, 2023.

(51) Int. Cl. G06F 3/04845; G06F 3/0482

(52) U.S. Cl. CPC G06F 3/04845; G06F 3/0482

(57) ABSTRACT

Systems and methods are provided for summoning a toolbar and digital assets in a collaboration workspace. The method includes receiving, by a server device, data related to a collaboration workspace including a toolbar displayed, by a large format display of a client device, at a first location in the collaboration workspace displayed on the large format display. The toolbar includes user interface elements for interacting with the collaboration workspace using the large format display. The method includes determining, by the server device, a second location in the collaboration workspace using the received data. The method includes sending, by the server device, collaboration data causing and/or allowing the toolbar including the user interface elements to move to the second location in the collaboration workspace. The collaboration data also causing and/or allowing display of the toolbar including the user interface elements at the second location.

### PRIORITY APPLICATION

This application claims the benefit of U.S. Provisional Patent Application No. 63/459,223 (Attorney Docket No. HAWT 1047-1), entitled, “A METHOD AND SYSTEM FOR SUMMONING ADAPTIVE TOOLBAR ITEMS AND DIGITAL ASSETS ASSOCIATED THEREWITH ON A LARGE FORMAT SCREEN WITHIN A DIGITAL COLLABORATION ENVIRONMENT,” filed on 13 Apr. 2023, which application is incorporated herein by reference.

### FIELD OF INVENTION

The present technology relates to collaboration systems that enable users to actively collaborate in a virtual workspace in a collaboration session. More specifically, the technology relates to tools and digital assets that can be summoned, on a digital display, closer to a user's physical position with respect to the digital display.

### BACKGROUND

Collaboration systems are used in a variety of environments to allow users to participate in content generation and content review. Users of a collaboration system can join collaboration sessions from locations around the world.

During a collaboration session, the participants of a collaboration session can draw on a digital whiteboard. Participants can draw or annotate to present ideas and/or provide comments on digital assets displayed on a workspace (also referred to as a virtual workspace, a digital whiteboard, or an online whiteboard). Various participants of the collaboration session can use different types of digital displays with a variety of display sizes, image resolutions, etc. When large digital displays (e.g., with heights and/or widths greater than five feet) are used in a collaboration session, user interface elements such as toolbars may be positioned away from a user's position. As the user moves from one location to another location, she may not be able to reach the tools on the toolbar. The user may have to then move to another location to access the toolbar or access other user interface elements to reposition the toolbar to a new location that is close to area of the digital display where the user is working or intends to work. This can be disruptive and inconvenient for users of a large digital displays. This same problem can be present for users interacting with digital displays that are smaller, as well. For example, even with a 40 inch diagonal screen (or multiple smaller screens working in conjunction), the distance between a user's point of interaction (e.g., a mouse pointer, a touch pointer, etc.) and a static toolbar can be prohibitive of the user efficiently interacting with the toolbar.

An opportunity arises to provide a technique for repositioning the toolbar closer to a user's current location (or point of interaction) as the user moves from one location to another while working on a large format digital display.

### SUMMARY

A system and method for summoning a toolbar is provided. The method includes receiving, by a server device, data related to a collaboration workspace including a toolbar displayed, by a large format display of a client device, at a first location in the collaboration workspace displayed on the large format display. The toolbar includes user interface elements for interacting with the collaboration workspace using the large format display. The method includes determining, by the server device, a second location in the collaboration workspace using the received data. The method includes sending, by the server device, collaboration data causing and/or allowing the toolbar including the user interface elements to move to the second location in the collaboration workspace, and causing and/or allowing display of the toolbar including the user interface elements at the second location.

In one implementation, the method includes sending, by the server device, collaboration data causing and/or allowing the toolbar including the user interface elements to move to or near the second location in the collaboration workspace. The method also includes causing and/or allowing display of the toolbar including the user interface elements at a location that is at a distance of least ten pixels from the second location.

The toolbar including the user interface elements can be displayed at a location that is at a distance of least one inch from the second location.

In one implementation, the method includes receiving, by the server device, data related to the second location of the collaboration workspace. The method includes sending, by the server device, the collaboration data causing and/or allowing moving of the toolbar to or near the first location, and causing and/or allowing display of the toolbar at or near the first location.

In one implementation, the method includes, sending, by the server device, the collaboration data causing and/or allowing display of a user interface element at or near the second location of the collaboration workspace in response to a first user input. The method includes receiving, by the server device, a second user input indicating selection of the user interface element. The method includes sending, by the server device, the collaboration data causing moving of the toolbar to or near the second location, and causing and/or allowing display of the toolbar at or near the second location.

In one implementation, the method includes, receiving, by the server device, data related to the second location of the collaboration workspace. The method includes sending, by the server device, the collaboration data causing and/or allowing collapsing of the toolbar to a compact form. The collapsed toolbar in the compact form can be of a smaller display size than the toolbar. The method includes hiding at least one user interface element and causing and/or allowing moving of the collapsed toolbar to or near the second location. The method includes causing and/or allowing the display of the collapsed toolbar at or near the second location.

In one implementation, the method includes, receiving, by the server device, data related to the second location of the collaboration workspace. The method includes sending, by the server device, the collaboration data causing and/or allowing expanding of the collapsed toolbar to display the toolbar, at the second location, to include at least one of the hidden user interface elements.

In one implementation, the method includes, receiving, by the server device, a first input via a large format display displaying a collaboration workspace. The collaboration workspace can include at least one digital asset, of a plurality of digital assets, positioned on a first location. The method includes generating, by the server device, a minified map of the collaboration workspace. The minified map can include a miniaturized representation the at least one digital asset of the plurality of digital assets. The method includes determining, by the server device, a second location in the collaboration workspace using a location on the large format display on which the first input is received. The method includes, sending, by the server device, collaboration data causing and/or allowing display of the minified map on the large format display at the second location. The method includes receiving, by the server device, a second input on the large format display. The second input selecting the miniaturized representation of the at least one digital asset in the minified map. The method includes sending, by the server device, collaboration data causing and/or allowing panning the collaboration workspace, such that the panning moves the at least one digital asset close to the location of the minified map on the large format display.

The minified map can include partitions of the workspace. At least one partition of the workspace comprises the at least one digital asset of the plurality of digital assets. The method includes receiving, by the server device, the second input on the large format display, the second input selecting the at least one partition of the workspace comprising the at least one digital asset of the plurality of digital assets.

In one implementation, the method includes receiving, by the server device, a user input including a third location for summoning the minified map. The method includes sending, by the server device, collaboration data causing and/or allowing moving of the minified map to a location at or near the third location and causing and/or allowing display of the minified map at the location.

In one implementation, the method includes receiving, by the server device, user input including at least one digital asset to move to a third location. The method includes sending, by the server device, collaboration data including an updated location of the at least one digital asset. The updated location is at or near the third location. The method includes causing and/or allowing the display of the at least one digital asset at or near the third location.

Systems which can be executed using the methods are also described herein.

Computer program products which can execute the methods presented above are also described herein (e.g., a non-transitory computer-readable recording medium having a program recorded thereon, wherein, when the program is executed by one or more processors the one or more processors can perform the methods and operations described above).

Other aspects and advantages of the present technology can be seen on review of the drawings, the detailed description, and the claims, which follow.

### BRIEF DESCRIPTION OF THE DRAWINGS

The technology will be described with respect to specific embodiments thereof, and reference will be made to the drawings, which are not drawn to scale, described below.

FIGS. 1 and 2 illustrate example aspects of a system implementing logic for summoning a toolbar (comprising a plurality of groups of tools or user interface elements) on a digital display or a large format digital display in a collaboration session.

FIGS. 3A, 3B, 3C and 3D present illustrations of triggering of the summon toolbar or gather toolbar functionality and resulting movement of the toolbar on the digital display.

FIGS. 4A and 4B present an example in which the toolbar is summoned to a location on the large format display that is close to the position of the user.

FIGS. 5A and 5B present another example in which a user triggers summon toolbar or gather toolbar functionality.

FIGS. 6A and 6B present an illustration in which the user sends the toolbar back to its original location after using the tools in the toolbar.

FIGS. 7A and 7B present an illustration in which the user summons the toolbar to a location by providing an input at that location on the digital display.

FIGS. 8A, 8B, 8C and 8D present another illustration in which the user summons a toolbar to a desired location or a target location on the digital display.

FIG. 9 presents a computer system that implements summoning or gathering of toolbar and digital assets closer to a user's location with respect to a large format digital display.

### DETAILED DESCRIPTION

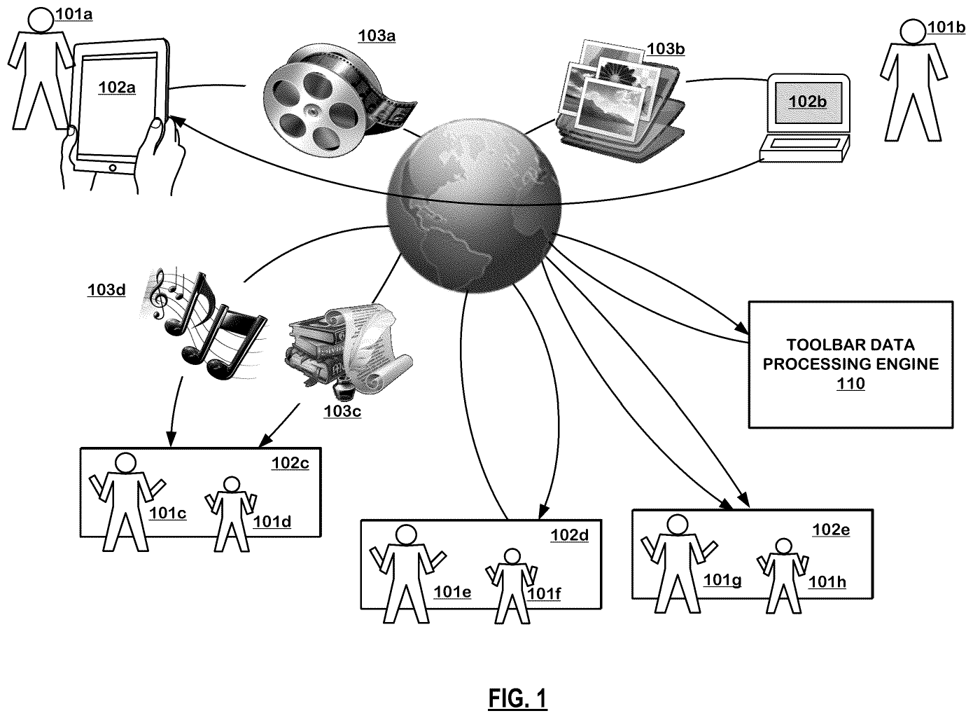

A detailed description of embodiments of the present technology is provided with reference to FIGS. 1-9.

The following description is presented to enable a person skilled in the art to make and use the technology and is provided in the context of a particular application and its requirements. Various modifications to the disclosed embodiments will be readily apparent to those skilled in the art, and the general principles defined herein may be applied to other embodiments and applications without departing from the spirit and scope of the present technology. Thus, the present technology is not intended to be limited to the embodiments shown, but is to be accorded the widest scope consistent with the principles and features disclosed herein.

### INTRODUCTION

Collaboration systems are used in a variety of environments to allow users to contribute and participate in content generation and review. Users of collaboration systems can join collaboration sessions from remote locations around the globe. The participants of a collaboration session can review, edit, organize and comment on a variety of digital asset, such as documents, slide decks, spreadsheets, images, videos, software applications, program code, user interface designs, search results from one or more sources of digital assets and/or search engines, etc.

The technology disclosed allows participants to collaborate using a variety of collaboration models. For example, in a leader-follower collaboration model, one participant acts as a leader of the collaboration session and other participants in the collaboration session follow the leader and view portions of the digital whiteboard (also referred to as a workspace, a virtual workspace, a collaboration workspace, a digital canvas, a display canvas and/or a canvas) on which the leader is working or view a portion of the workspace that is being presented by the leader. In another collaboration model, multiple participants can simultaneously work on digital assets in the workspace and co-edit digital assets in a digital whiteboard at different locations.

The users or participants of the collaboration system can participate in a collaboration session by using a variety of computing devices. Some of these computing devices have small format displays (or small format screens) such as mobile computing devices including cell phones, tablets, laptop computers and desktop computers etc. Some users of the collaboration system can participate from a location such as a meeting room in an office building or a classroom in a school that is fitted with a large format display. The large format displays can have display sizes up to 85 inches (around 7 feet) or more. In some cases, two or more large format displays are arranged horizontally (or vertically) to provide larger display sizes. In some cases, large format displays are arranged in a two-by-two format in which four large format displays are arranged in a 2×2 matrix organization. In some cases, more than four large format digital displays may be arranged to provide even larger display surfaces. Working on such large display surfaces presents certain challenges that can impact the quality and efficiency of the collaboration sessions. The technology disclosed allows participants of the collaboration session to collaborate efficiently using large format digital displays (or large format display screens).

Large format displays and arrangements of multiple large format displays that further increase the display space or display surface for presenting the digital whiteboard pose many challenges for the users during a collaboration session. For example, the user interface elements (or graphical icons) representing the various tools to support the collaboration and interaction with digital assets can be positioned near the top edge of the digital display. The user interface elements for some tools may be positioned along the left and right edges of the digital display. The collaboration system can provide toolbars containing user interface elements for various collaboration tools. The toolbars can be positioned near the top edge of the digital display and/or along the right and left edges of the digital display. It can be challenging for the users to access or interact with the tools (or user interface elements representing the tools) in the toolbars displayed on large format displays that are more than six feet in height as the user may not be able to reach that height to select the desired graphical icons (or user interface elements) in the toolbar. In some cases, large format digital displays can present challenges for users with short heights, because they may not be able to physically reach the top portions of the large display surface. Additionally, users with accessibility issues such as users on wheelchairs may not be able to access toolbars displayed in the top-half of a large format digital display. Further, when a user is standing on one end (e.g., on a left side) of a large format digital display, accessing user interface elements in a toolbar displayed on the other end (e.g., on a right side) of the large format display may be cumbersome or time consuming, or may not even be possible.

When using large format displays in collaboration sessions, the users are also challenged (due to physical distances) when accessing digital assets located in different portions of the digital whiteboard. The digital assets located in a top-half portion of a large format digital display may not be easily accessible. Similarly, when the user is standing on one side of a large format display, the digital assets located in the digital whiteboard on the opposite side may not be easily accessible. The above-mentioned accessibility issues become more challenging for users on wheelchairs or users with short heights. The users working on large format displays or arrangements of displays in which multiple large format displays are arranged together to provide large display surfaces often need to perform numerous pan and zoom operations to access their desired digital assets during a collaboration session. This process can become very time-consuming resulting in lowering of user's productivity and wastage of useful meeting time. Additionally, if there is significant space between the toolbars (or the tools of the toolbars) and the digital assets that the user is interacting with, the user will need to make large gestures and/or movements between the toolbars (or tools) and the digital assets, which can eventually lead to user fatigue due to continuous arm/hand movements, head movements, etc.

The technology disclosed enables users of the collaboration system to easily interact with digital assets displayed on large format displays without performing large and cumbersome gestures/movements and without performing pan and zoom operations. All regions of the digital whiteboard of the collaboration system become easily accessible to users with all types of physical constraints such as different heights and accessibility requirements. The technology disclosed, therefore, provides an accessibility model for collaboration sessions that are conducted using large format displays. The technology disclosed provides tools and processes that allow users of all types of heights and physical conditions to efficiently use large format displays to lead collaboration sessions by interacting with digital assets positioned in digital whiteboards (or workspaces).

The technology disclosed provides a so-called “gather tools” or “summon tools” functionality that allows a user to summon a toolbar or tools that are positioned on different parts of a digital display and that are not easily accessible to the user. For example, the toolbar or the tools may be positioned along the top edge of a large format display. The toolbar or the tools may also be positioned on one side of the large format display and the user may be positioned close to the other side of the large format display. In such scenarios, the user can trigger the “summon tools” or “gather tools” functionality that causes the toolbar or the tools to relocate to a position on the digital whiteboard that is closer to the position of the user or closer to the position on the digital whiteboard at which the user interacted to trigger the “summon tools” or “gather tools” functionality. In one implementation, the technology disclosed brings the toolbar as-is on a position in the digital whiteboard that is closer to the position of the user.

In another implementation, the technology disclosed collapses the toolbar in a compact form and then brings the compact form toolbar to a position on the digital whiteboard that is closers to the position of the user. The toolbar is also referred to as an “adaptive toolbar” that can be collapsed and expanded to full or complete form when required by the user. When displayed in the expanded or full form, the toolbar can collapse automatically after a tool has been selected by the user. The user can also provide a command to collapse or expand the toolbar as required. In a collapsed form, the toolbar requires less space for display on the digital whiteboard thus allowing more of the content to be displayed on the digital display without being overlapped by the toolbar. In one implementation, when a user, who is acting as a leader in a collaboration session (in a leader-follower collaboration session), summons a toolbar, the summon toolbar operation is performed only at the leader's computing device. The respective positions of toolbars are not updated on the digital displays linked to computing devices of other participants (or followers) of the collaboration session.

The technology disclosed provides a so-called “minified map” of the digital whiteboard to the user close to a position on the digital whiteboard at which the user interacted with the digital display to trigger the “summon tools” or “gather tools” functionality. The “minified map” of the digital whiteboard can include small-sized caricatures of digital assets on the digital whiteboard. The user can select a caricature of a digital asset on the “minified map” to automatically pan the digital whiteboard and bring the selected digital asset closer to the position on the digital display at which the user interacted to trigger the “summon tools” or “gather tools” functionality.

The following sections present some key elements of the collaboration system, followed by details of the technology disclosed.

### Workspace or Virtual Workspace

In order to support an unlimited amount of spatial information for a given collaboration session, the technology disclosed provides a way to organize a virtual space termed the “workspace” (also referred to as a “virtual workspace”, “collaboration workspace” or a “digital whiteboard”). The workspace can be characterized by a multi-dimensional and in some cases two-dimensional plane with essentially unlimited extent in one or more dimensions for example, in such a way that new content can be added to the space. The content can be arranged and rearranged in the space, and a user can navigate from one part of the space to another.

Digital assets (or objects), in a collaboration session, are arranged on the workspace. Their locations in the workspace are important for performing the gestures. One or more digital displays in the collaboration session can display a portion of the workspace, where locations on the display are mapped to locations in the workspace. The toolbars comprising user interface elements representing various tools for operating on the digital assets are also displayed on the workspace along a top edge of the digital display and/or along the left and right edges of the digital display.

### Viewport

One or more digital displays in the collaboration session can display a portion of the workspace, where locations on the display are mapped to locations in the workspace. A mapped area, also known as a viewport within the workspace is rendered on a physical screen space. Because the entire workspace is addressable using coordinates of locations, any portion of the workspace that a user may be viewing itself has a location, width, and height in coordinate space. The concept of a portion of a workspace can be referred to as a “viewport”. The coordinates of the viewport are mapped to the coordinates of the screen space. The coordinates of the viewport can be changed which can change the objects contained within the viewport, and the change would be rendered on the screen space of the display client. Details of the workspace and the viewport are presented in U.S. patent application Ser. No. 15/791,351 (Atty. Docket No. HAWT 1025-1), entitled, “Virtual Workspace Including Shared Viewport Markers in a Collaboration System,” filed on Oct. 23, 2017, now issued as U.S. Pat. No. 11,126,325, which is fully incorporated into this application by reference. In case of a leader-follower model of collaboration, the viewport at the follower's computing device displays the same portion of the workspace as displayed in the viewport of the leader's computing device. The technology disclosed enables the leader to summon a remote portion of the workspace closer to the position of the user when using a large format digital display. This change in the viewport of the leader's large format display may not be reflected in the viewport of the computing device of the followers as the followers may not be interacting with the digital assets on the workspace. The viewport of digital displays of followers can keep displaying the same portion of the viewport as being displayed on the leader's digital display prior to the leader summoning content from a distant position on the workspace. If the content summoned by the leader is not within the viewport of digital display of one or more followers, the respective viewports of digital displays of followers can update to display the viewport of the leader's large format display.

### Spatial Event Map

The “unlimited workspace” problem includes the need to track how people (or users) and devices interact with the workspace over time. In order to solve this core problem, the technology disclosed includes a so-called “spatial event map”. The spatial event map contains information needed to define digital assets and events in a workspace. It is useful to consider the technology from the point of view of space, events, maps of events in the space, and access to the space by multiple users, including multiple simultaneous users. The spatial event map can be considered (or represent) a sharable container of digital assets that can be shared with other users. The technology disclosed includes logic to generate a “minified map” or a “minified view” of the workspace. The minified map can present an outline of digital assets (such as in the form of caricatures) to present an overall view of the workspace to the user in a small window. When a user invokes the summon toolbar or gather toolbar functionality (i.e., by performing a gesture or providing an input), the technology disclosed can generate the “minified map” of the workspace using the collaboration data stored in the spatial event map. The spatial event map includes location data of the digital assets in a two-dimensional or a three-dimensional space. The technology disclosed uses the location data and other information about the digital assets (such as the type of digital asset, shape, color, etc.) to generate the minified map of the workspace (also referred to as the digital whiteboard). The minified map can be displayed on the digital display near the location on the large format display at which the user performed the gesture or provided the input to invoke the “gather toolbar” or “summon toolbar” functionality.

When the minified map is displayed, the user can select a digital asset from the minified map. The technology disclosed includes logic to automatically perform a pan operation on the workspace to bring the selected digital asset close the position of the user. In one implementation, the minified map can indicate different regions of the workspace such as top-left (north-west or NW) region, top-right (north-east or NE) region, bottom-left (south-west or SW) region and bottom-right (south-east or SE) region. The user can select a region (such as the top-right region) to display the digital assets in the selected (i.e., the top-right) region of the workspace on the large format display, close to the position of the user.

The technology disclosed includes logic to provide the toolbar and the required digital assets close the position of the user on a large format digital display. This can improve the efficiency of conducting the collaboration sessions and reduce the time required to pan and zoom the workspace on a large digital display to get to a desired digital asset or to a desired region (or portion) of the workspace. The technology disclosed not only brings the toolbar close to a position on the digital display where it is easily accessible by the user but also includes logic to bring the content or digital assets on the workspace closer to a position on a large format display from where it is easily accessible by the user. The technology disclosed builds this accessibility model on top of the spatial event map technology. The spatial event map provides the required data about the digital assets located in the workspace for generation of the minified map of the workspace.

A spatial event map contains data related to digital assets in the workspace for a given collaboration session. The spatial event map defines arrangement of digital assets on the workspace. The locations of digital assets in the workspace are important for performing gestures or for performing other types of operations such as edits to contents of digital assets, etc. The spatial event map contains information needed to define digital assets, their locations, and events in the workspace. A spatial events map system, maps portions of workspace to a digital display e.g., a touch enabled display. Details of workspace and spatial event map are presented in our U.S. application Ser. No. 14/090,830 (Atty. Docket No. HAWT 1011-2), entitled, “Collaboration System Including a Spatial Event Map,” filed Nov. 26, 2013, now issued as United States Patent No. U.S. Pat. No. 10,304,037, which is included in this application and fully set forth herein. Any changes to the digital assets are reflected in the spatial event map using the events. The spatial event map can be shared with other users and multiple users can collaboratively work on the refinements, editing, selection, curation of digital assets.

The server node (or server-side node or server-side network node) provides at least a portion of the spatial event map identifying events in the virtual workspace to client nodes (or client-side nodes or client-side network nodes). The spatial event map allows for displaying or rendering a portion of the shared virtual workspace in the display space on the display of the client nodes. The shared virtual workspace can include one or more digital assets. As updates are detected to the shared virtual workspace in response to input events at one or more client nodes, the server node sends update events to spatial event maps at the other client nodes.

The client node receives, from the server node, at least a portion of the spatial event map identifying events in the virtual workspace. The spatial event map allows the client node to display or render at least a portion of the shared virtual workspace. The shared virtual workspace can include one or more digital assets. The client node can send update events to server node in response to input events at the client node. The client node can receive updates events from the server node in response to input events at one or more other client nodes.

### Space

In order to support an unlimited amount of spatial information for a given collaboration session, the technology disclosed provides a way to organize digital assets in a virtual space termed as the workspace, which can, for example, be characterized by a 2-dimensional plane (along X-axis and Y-axis) with essentially unlimited extent in one or both dimensions, for example. The workspace is organized in such a way that new content such as digital assets can be added to the space, that content can be arranged and rearranged in the space, that a user can navigate from one part of the space to another, and that a user can easily find needed things in the space when it is needed. The technology disclosed can also organize content on a 3-dimensional workspace (along X-axis, Y-axis, and Z-axis).

### Events

Interactions with the workspace can be handled as events. People, via tangible user interface devices, and systems can interact with the workspace. Events have data that can define or point to a target digital asset to be displayed on a physical display, and an action as creation, modification, movement within the workspace and deletion of a target digital asset, and metadata associated with them. Metadata can include information such as originator, date, time, location in the workspace, event type, security information, and other metadata.

Tracking events in a workspace enables the system to not only present the spatial events in a workspace in its current state, but to share it with multiple users on multiple displays, to share relevant external information that may pertain to the content and the understanding of how the spatial data evolves over time. Also, the spatial event map can have a reasonable size in terms of the amount of data needed, while also defining an unbounded workspace.

The summon toolbar or gather toolbar technology is described below in the context of a collaboration environment in which a plurality of users can be participate in a collaboration session.

### Environment

FIG. 1 illustrates example aspects of a digital display collaboration environment. In the example, a plurality of users 101a, 101b, 101c, 101d, 101e, 101f, 101g and 101h (collectively 101) may desire to collaborate with each other when reviewing various types of content including digital assets including documents, images, videos and/or web applications or websites. The plurality of users may also desire to collaborate with each other in the creation, review, and editing of digital assets such as complex images, music, video, documents, and/or other media, all generally designated in FIGS. 1 as 103a, 103b, 103c, and 103d (collectively 103). The participants or users in the illustrated example use a variety of computing devices configured as electronic network nodes, in order to collaborate with each other, for example a tablet 102a, a personal computer (PC) 102b, many large format displays 102c, 102d, 102c (collectively devices 102). The participants can also use one or more mobile computing devices and/or tablets with small format displays to collaborate. In the illustrated example the large format display 102c, which is sometimes referred to herein as a “wall”, accommodates more than one of the users, (e.g., users 101c and 101d, users 101e and 101f, and users 101g and 101h).

In an illustrative embodiment, a display array can have a displayable area usable as a screen space totaling on the order of 6 feet in height and 30 feet in width, which is wide enough for multiple users to stand at different parts of the wall and manipulate it simultaneously. It is understood that large format displays with displayable area greater than or less than the example displayable area presented above can be used by participants of the collaboration system. The one or more large format displays 102c, 102d and/or 102e can have display sizes up to 85 inches (around 7 feet) or more. In some cases, a large format display such as 102c, 102d and/or 102e comprises two or more digital displays or large format digital displays arranged horizontally (or vertically) to provide larger display sizes. In such cases, large format displays can be arranged in a two-by-two format in which four large format displays are arranged in a 2×2 matrix organization to create larger display area or display surface. In some cases, more than four large format digital displays may be arranged to provide even larger display surfaces. Working on such large display surfaces presents certain challenges that can impact the quality and efficiency of the collaboration sessions. The technology disclosed allows participants of the collaboration session to collaborate efficiently using large format digital displays (or large format display screens).

The user devices, which are referred to as client nodes, have displays on which a screen space is allocated for displaying events in a workspace. The screen space for a given user may comprise the entire screen of the display, a subset of the screen, a window to be displayed on the screen and so on, such that each has a limited area or extent compared to the virtually unlimited extent of the workspace.

The collaboration system of FIG. 1 includes a toolbar data processing engine 110 that implements logic to receive input from users of the collaboration session indicating a desired location on a large format digital display at which the user intends to work. The toolbar data processing engine includes logic to summon or gather toolbars near the target location so that the user can easily access the tools needed for the collaboration session. The toolbar data processing engine can perform this operation at a particular client node at the which the user invokes summon toolbar or gather toolbar functionality. Locations of toolbars displayed at the digital displays of other client nodes are not changed or updated. The toolbar data processing engine can receive further inputs from the user to reposition the toolbars at their respective default or original locations when the user completes her work at a particular location on the large format digital display. The toolbar data processing engine 110 also includes logic to gather or summon digital assets to a location on the large format display that is closer to the position of the user. One or more digital assets that the user has recently worked on such as in the last thirty minutes or the last one hour can be brought closer to the location at which the user is currently working. In another implementation, a minified map is displayed at a location closer to the location of the user. The minified map can display caricatures of the digital assets on the workspace. The user can select digital assets from the minified map to summon the selected digital assets. The digital assets can be reverted back to the previous or original location on the workspace when the user complete her work. In one implementation, the toolbar data processing engine 110 includes to logic to display the toolbars in a collapsed form at the target location to save space. The collapsed toolbars are displayed in expanded form when a user interacts with the collapsed toolbar such as by selecting a user interface element on the collapsed toolbar. The toolbar data processing engine 110 can be implemented in the server node. In one implementation, a portion of the logic implemented by the toolbar data processing engine can be implemented at the client node.

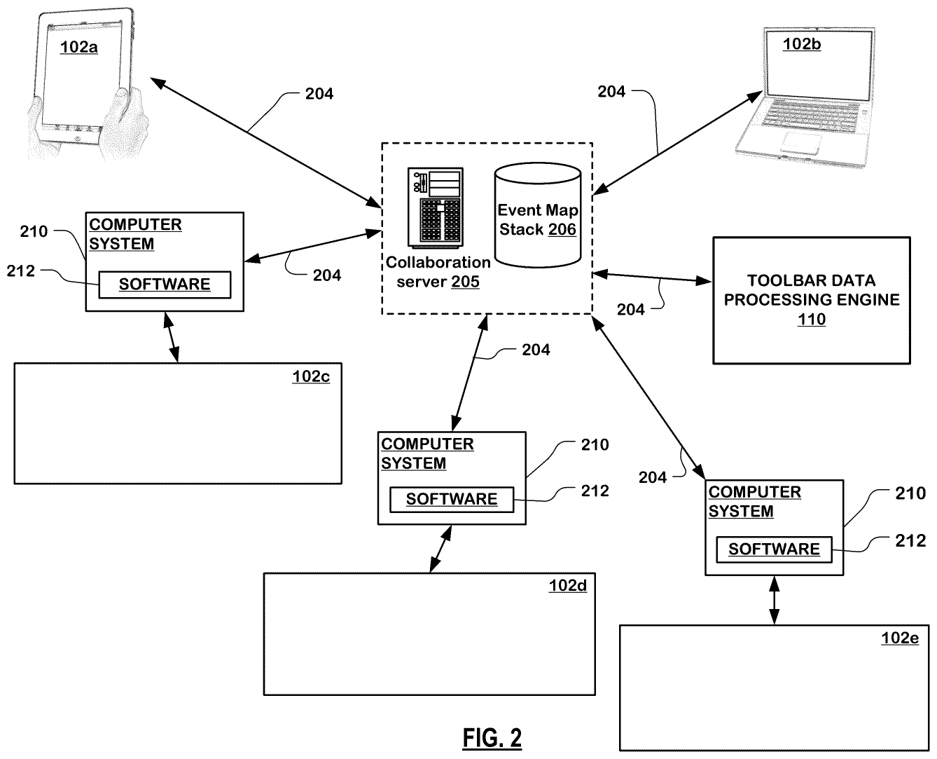

FIG. 2 shows a collaboration server 205 (also referred to as the server node or the server node) and a database 206 that can constitute a server node. The server node is configured with logic to receive stroke data from a client node and process this data prior to propagating to other client nodes in the collaboration session. Similarly, FIG. 2 shows client nodes (or client nodes) that can include computing devices such as desktop and laptop computer, hand-held devices such as tablets, mobile computers, smart phones, and large format displays that are coupled with computer system 210. Participants of the collaboration session can use a client node to participate in a collaboration session.

FIG. 2 illustrates additional example aspects of a digital display collaboration environment. As shown in FIG. 1, the large format displays 102c, 102d, 102e sometimes referred to herein as “walls” are controlled by respective client, communication networks 204, which in turn are in network communication with a central collaboration server 205 configured as a server node or nodes, which has accessible thereto a database 206 storing spatial event map stacks for a plurality of workspaces. The database 206 can also be referred to as an event map stack or the spatial event map as described above. The data processing engine 110 can be implemented as part of the collaboration server 205 or it can be implemented separately and can communicate with the collaboration server 205 via the communication networks 204.

As used herein, a physical network node is an active electronic device that is attached to a network, and is capable of sending, receiving, or forwarding information over a communication channel. Examples of electronic devices which can be deployed as network nodes, include all varieties of computers, workstations, laptop computers, handheld computers and smart phones. As used herein, the term “database” does not necessarily imply any unity of structure. For example, two or more separate databases, when considered together, still constitute a “database” as that term is used herein.

The application running at the collaboration server 205 can be hosted using software such as Apache or nginx, or a runtime environment such as node.js. It can be hosted for example on virtual machines running operating systems such as LINUX. The collaboration server 205 is illustrated, heuristically, in FIG. 2 as a single computer. However, the architecture of the collaboration server 205 can involve systems of many computers, each running server applications, as is typical for large-scale cloud-based services. The architecture of the collaboration server 205 can include a communication module, which can be configured for various types of communication channels, including more than one channel for each client in a collaboration session. For example, with near-real-time updates across the network, client software can communicate with the server communication module using a message-based channel, based for example on the WebSocket protocol. For file uploads as well as receiving initial large volume workspace data, the client software 212 (as shown in FIG. 2) can communicate with the collaboration server 205 via HTTPS. The collaboration server 205 can run a front-end program written for example in JavaScript served by Ruby-on-Rails, support authentication/authorization based for example on OAuth, and support coordination among multiple distributed clients. The collaboration server 205 can use various protocols to communicate with client nodes. Some examples of such protocols include REST-based protocols, low latency web circuit connection protocol and web integration protocol. Details of these protocols and their specific use in the co-browsing technology is presented below. The collaboration server 205 is configured with logic to record user actions in workspace data, and relay user actions to other client nodes as applicable. The collaboration server 205 can run on the node.JS platform for example, or on other server technologies designed to handle high-load socket applications.

The database 206 stores, for example, a digital representation of workspace data sets for a spatial event map of each session where the workspace data set can include or identify events related to objects displayable on a display canvas, which is a portion of a virtual workspace. The database 206 can store digital assets and information associated therewith, as well as store the raw data, intermediate data and graphical data at different fidelity levels, as described above. A workspace data set can be implemented in the form of a spatial event stack, managed so that at least persistent spatial events (called historic events) are added to the stack (push) and removed from the stack (pop) in a first-in-last-out pattern during an undo operation. There can be workspace data sets for many different workspaces. A data set for a given workspace can be configured in a database or as a machine-readable document linked to the workspace. The workspace can have unlimited or virtually unlimited dimensions. The workspace data includes event data structures identifying digital assets displayable by a display client in the display area on a display wall and associates a time and a location in the workspace with the digital assets identified by the event data structures. Each device 102 displays only a portion of the overall workspace. A display wall has a display area for displaying objects, the display area being mapped to a corresponding area in the workspace that corresponds to a viewport in the workspace centered on, or otherwise located with, a user location in the workspace. The mapping of the display area to a corresponding viewport in the workspace is usable by the display client to identify digital assets in the workspace data within the display area to be rendered on the display, and to identify digital assets to which to link user touch inputs at positions in the display area on the display.

The collaboration server 205 and database 206 can constitute a server node, including memory storing a log of events relating to digital assets having locations in a workspace, entries in the log including a location in the workspace of the digital asset of the event, a time of the event, a target identifier of the digital asset of the event, as well as any additional information related to digital assets, as described herein. The collaboration server 205 can include logic to establish links to a plurality of active client nodes (e.g., devices 102), to receive messages identifying events relating to modification and creation of digital assets having locations in the workspace, to add events to the log in response to said messages, and to distribute messages relating to events identified in messages received from a particular client node to other active client nodes.

The logic in the collaboration server 205 can comprise an application program interface, including a specified set of procedures and parameters, by which to send messages carrying portions of the log to client nodes, and to receive messages from client nodes carrying data identifying events relating to digital assets which have locations in the workspace. Also, the logic in the collaboration server 205 can include an application interface including a process to distribute events received from one client node to other client nodes.

The events compliant with the API can include a first class of event (history event) to be stored in the log and distributed to other client nodes, and a second class of event (ephemeral event) to be distributed to other client nodes but not stored in the log.

The collaboration server 205 can store workspace data sets for a plurality of workspaces and provide the workspace data to the display clients participating in the session. The workspace data is then used by the computer systems 210 with appropriate software 212 including display client software, to determine images to display on the display, and to assign digital assets for interaction to locations on the display surface. The server 205 can store and maintain a multitude of workspaces, for different collaboration sessions. Each workspace can be associated with an organization or a group of users and configured for access only by authorized users in the group.

In some alternatives, the collaboration server 205 can keep track of a “viewport” for each device 102, indicating the portion of the display canvas (or canvas) viewable on that device, and can provide to each device 102 data needed to render the viewport. The display canvas is a portion of the virtual workspace. Application software running on the client device responsible for rendering drawing objects, handling user inputs, and communicating with the server can be based on HTML5 or other markup-based procedures and run in a browser environment. This allows for easy support of many different client operating system environments.

The user interface data stored in database 206 includes various types of digital assets including graphical constructs (drawings, annotations, graphical shapes, etc.), image bitmaps, video objects, multi-page documents, scalable vector graphics, and the like. The devices 102 are each in communication with the collaboration server 205 via a communication network 204. The communication network 204 can include all forms of networking components, such as LANs, WANs, routers, switches, Wi-Fi components, cellular components, wired and optical components, and the internet. In one scenario two or more of the users 101 are located in the same room, and their devices 102 communicate via Wi-Fi with the collaboration server 205.

In another scenario two or more of the users 101 are separated from each other by thousands of miles and their devices 102 communicate with the collaboration server 205 via the internet. The walls 102c, 102d, 102e can be multi-touch devices which not only display images, but also can sense user gestures provided by touching the display surfaces with either a stylus or a part of the body such as one or more fingers. In some embodiments, a wall (e.g., 102c) can distinguish between a touch by one or more fingers (or an entire hand, for example), and a touch by the stylus. In one embodiment, the wall senses touch by emitting infrared light and detecting light received; light reflected from a user's finger has a characteristic which the wall distinguishes from ambient received light. The stylus emits its own infrared light in a manner that the wall can distinguish from both ambient light and light reflected from a user's finger. The wall 102c may, for example, be an array of Model No. MT553UTBL MultiTaction Cells, manufactured by MultiTouch Ltd, Helsinki, Finland, tiled both vertically and horizontally. In order to provide a variety of expressive means, the wall 102c is operated in such a way that it maintains a “state.” That is, it may react to a given input differently depending on (among other things) the sequence of inputs. For example, using a toolbar, a user can select any of a number of available brush styles and colors. Once selected, the wall is in a state in which subsequent strokes by the stylus will draw a line using the selected brush style and color.

### Implementations of Summon Toolbar Technology

Large wall displays (also referred to as large format displays) can be very tall and some of the content displayed on large wall displays may be out of reach of some users. The tools provided by the collaboration system to support collaboration session maybe arranged along the top edge of a large wall display and thus out of reach of many users. People of differing heights may not be able to reach all locations on the display to be able to interact with it. Further, a person who is standing at the left side of the large display might want to remain on the left side rather than walking across the stage to the right side of the display to interact with content display on the digital display (digital assets, toolbar items, etc.). Further, some individuals with special needs such as in a wheelchair may have difficulty in reaching toolbar or digital assets displayed on top-half of a large format display. The technology disclosed provides an accessibility method to address the above-mentioned challenges in collaboration session when using large wall displays or large format displays. Some of the key features of the technology disclosed are presented below.

In one implementation, a user can move the toolbar from a first location on the digital display to a second location on the digital display.

In another implementation, triggering the “gather toolbar” or “summon toolbar” functionality moves the toolbar from a first location on the digital display to a second location on the digital display. The second location is closer to the position on the digital display at which the user is performing actions by providing an input or performing a gesture to trigger the “gather toolbar” or “summon toolbar” functionality. The movement of the toolbar from the first location to the second location and be animated to that the user (or observer) can see the toolbar move or the movement of the toolbar can be instantaneous without animation.

In yet another implementation, triggering the “gather toolbar” or “summon toolbar” functionality collapses the toolbar into a compact format. The toolbar then moves to a location on the digital display which is closer to the position of the user with respect to the digital display. The toolbar is displayed in a compact format until the user interacts with the toolbar. Upon interaction of the user, the toolbar expands to display graphical icons or user interface elements for all (or selected) tools in the toolbar. The user can select a tool from the toolbar. The user can also select a user interface element (or a graphical icon) to collapse the toolbar to compact form. The toolbar (also referred to as the adaptive toolbar) can also be rearranged in a different orientation or a different shape when it moves to its new location. The rearrangement and/or collapse of the toolbar items (or tools) can be predetermined, the arrangement can be adaptive based on contents (digital assets) currently displayed and/or based on previously acquired preferences of the user. The act of the toolbar transforming to the compact format from a regular format or from transforming from the compact format back to the regular format can be animated so that the user can see the transformation, or it can be instantaneous without animation.

When the toolbar is summoned from a first location to a second location on the large format display, the new location (or the second location) of the toolbar can be based on the location on the digital display from where the user triggered the “gather toolbar” or “summon toolbar” functionality. For example, the toolbar (or “adaptive toolbar” or “adaptive tools”) can move to a location on the large format display that is centered around the location of from where the user triggered the functionality. Alternatively, the toolbar can move to a location to the right, left, just above or just below the location at which the user triggered “gather toolbar” or “summon toolbar” functionality. The user can also interact with the toolbar to move it to a desired location from the new location. In one implementation, a toolbar moves to a predefined distance from the location at which the user triggered “gather toolbar” or “summon toolbar” functionality. For example, the toolbar can be positioned 10 pixels above the location at which the user triggered the “gather toolbar” or “summon toolbar” functionality. It is understood that other distances and orientations can be defined for identifying the destination or target location of the toolbar.

The new location of the toolbar or the adaptive tools can be adjusted based on the user's information known by the collaboration system. For example, the right or left handedness of the user can be considered. Further, the height or expected location of the user can be considered when selecting the destination location or target location of the toolbar.

The “gather toolbar” or “summon toolbar” functionality can be triggered by providing an input to a computing device (e.g., a right click). Large format displays usually include touch-enabled screens for interaction. Therefore, a “long press” can be used to trigger the functionality, as well as other menu items. If a long press is used, a progress meter can be displayed to let the user know how long they actually need to hold their finger to trigger the functionality. It is understood that other types of gestures or inputs such as double tap, triple tap, two-finger touch, etc. can be used to trigger the “gather toolbar” or “summon toolbar” functionality. Voice commands can also be used to provide input to the computing device to trigger the “gather toolbar” or “summon toolbar” functionality. The user can provide voice commands to the computing device to position the toolbar at a desired location. For example, the user can guide the system to “move left”, “move down”, “move right”, “stop”, etc. to summon the toolbar from a first location to a second (such as a destination or a target location).

The technology disclosed includes logic to help users navigate the workspace after the toolbar (or adaptive tools) are moved to their new location. In one implementation, the technology disclosed provides navigation tools to the user, so that for example, the user can press a button that will cause the digital assets that are on the upper righthand portion of the digital canvas to move to the lower lefthand portion (this is where the user is located) so that the user can more easily interact with the digital assets. In another implementation, the technology disclosed presents a menu item (overlay) that is near or on top of the adaptive tools that were just moved to the new location. This new menu item (also referred to as the minified map or overlay) can be a snapshot of what is currently being displayed on the entire screen (e.g., a snapshot of all or selected digital assets). The minified map or overlay can be presented in reduced resolution that is good enough so that the user can identify and select which portion of the display canvas (what is currently being displayed) should be centered or moved to the location of the adaptive tools. The minified map can also just be a square or rectangle broken into quadrants and the user can just pick which quadrant they are interested in (not limited to just 4 quadrants though—can be any number of sections). The minified map can also be pre-designed by the user with labels, so that the user knows which “area” to pick first, second, third, etc. This allows the user to (after they summon the adaptive tools to “their” location) cycle through different sections of digital assets on the workspace (also referred to as a canvas or a digital whiteboard).

The above-mentioned implementations of the toolbar (or the adaptive toolbar) can be implemented for multiple users. For example, say that two people are giving a presentation. The first user on the left-hand side can move the tools to their location using the process described above. The first user can cycle through their digital assets as described above. When it is time for the second user to take over the presentation on the righthand side of the large screen, they can implement the methods described above to move the adaptive tools to their location, etc.

The summoning of the content functionality is implemented using the workspace data provided by the spatial event map. In one implementation, the toolbar location, orientation and shape information are also stored in the spatial event map. The spatial event map can also store pre-defined preferences of arrangement of toolbar. The zoom, pan and other operations performed as a result of the gather toolbar or summon toolbar functionality can be stored in the spatial event map. The updates to the spatial event map are communicated as events to the collaboration server (also referred to as a server-side network node). In some cases, the server-side network node can propagate the updates to the spatial event map to other client-side computing devices (also referred to as client-side network nodes).

### Examples of Summoning a Toolbar

The technology disclosed enables users of all heights and having various physical constraints (such as on wheelchair, etc.) to efficiently participate in and lead collaboration sessions using a large format display with a height up to six feet or more. The technology disclosed is also applicable to large display surfaces that are composed of two or more large format displays placed together horizontally or vertically. Large format displays can be touch enabled, thus requiring the users to interact with the display during the collaboration session. Users have difficulty in accessing all parts of a large format display. For example, the user can have difficulty in reaching the top part of the large format display. Similarly, a user standing on one side (e.g., the left side) of the display will have difficulty in interacting with the digital display on the other side (e.g., the right side). In some cases, the users may have difficulty in reaching lower portion of the large format display. Therefore, using large format displays presents numerous challenges for users in a collaboration session. These challenges can decrease the productivity of users in a collaboration session. The technology disclosed provides an accessibility model that includes tools and methods that allow the users to efficiently access the tools and also conveniently interact with digital assets located at any position on the large format display.

The technology disclosed provides a system and method to address the various challenges in collaboration sessions due to large physical display sizes, physical limitations of users due to their heights and disabilities, and position of the users with respect to the large format display during the collaboration session. The technology disclosed allows a user to bring the tools or the toolbar closer to her location by triggering the summon toolbar or gather toolbar functionality. The toolbar can move to the desired location (or a target location), the user can use the tools from the toolbar and send it back to its original position which can be along the top edge of the display screen or along the left or right edge of the display. The user can send the toolbar to another destination if the user moves to another location and needs to use the tools on that location of the large format display. In another implementation, the “summon toolbar” or “gather toolbar” functionality causes the toolbar to collapse to a compact form and then move to the desired location on the large format display. The toolbar can then be expanded when desired by the user by performing a gesture or providing an input.

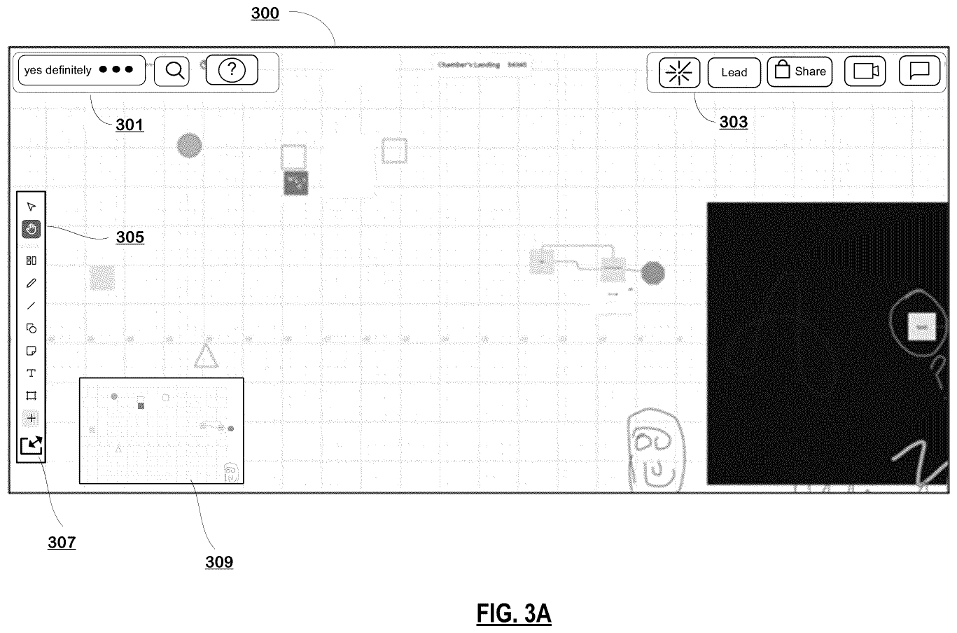

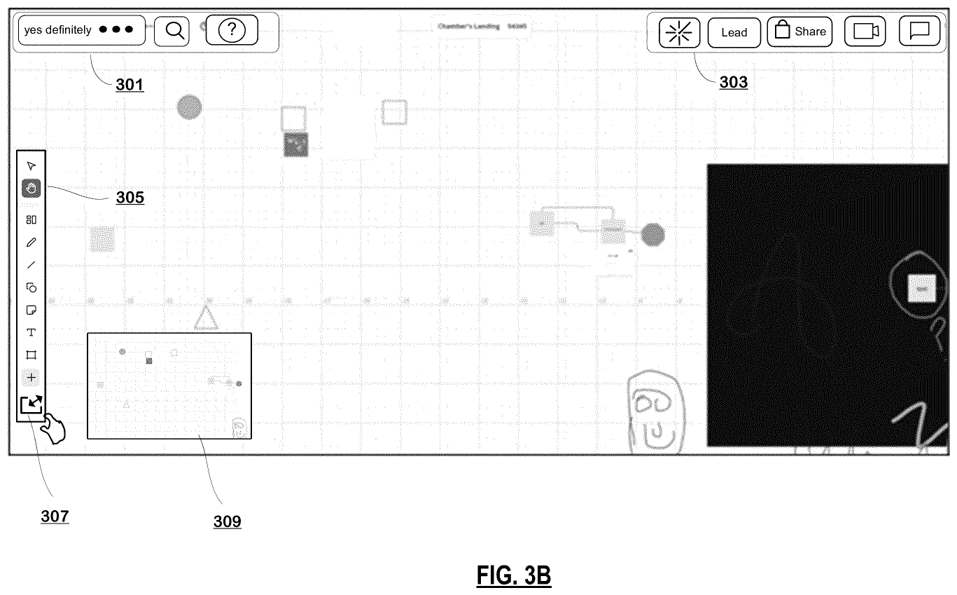

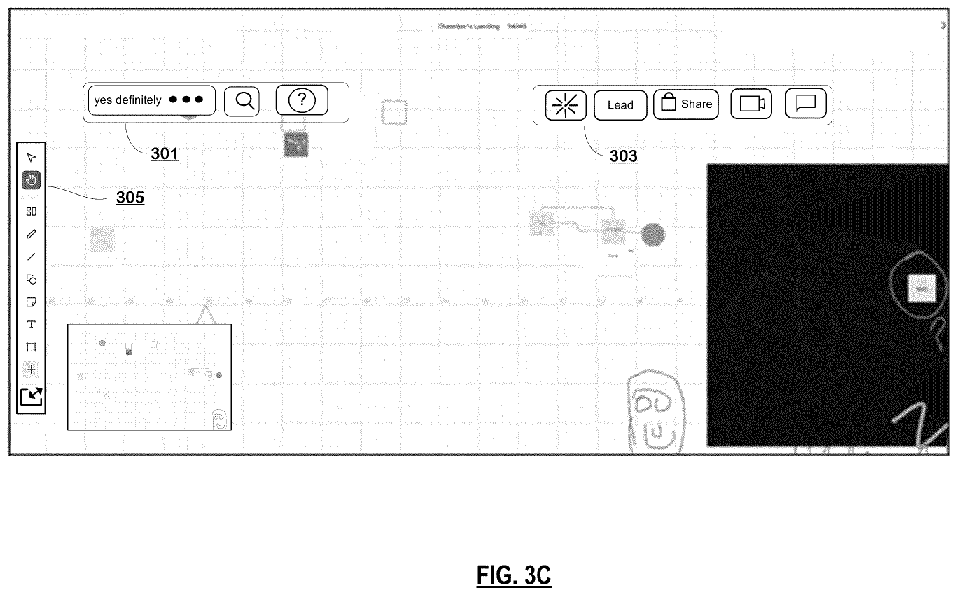

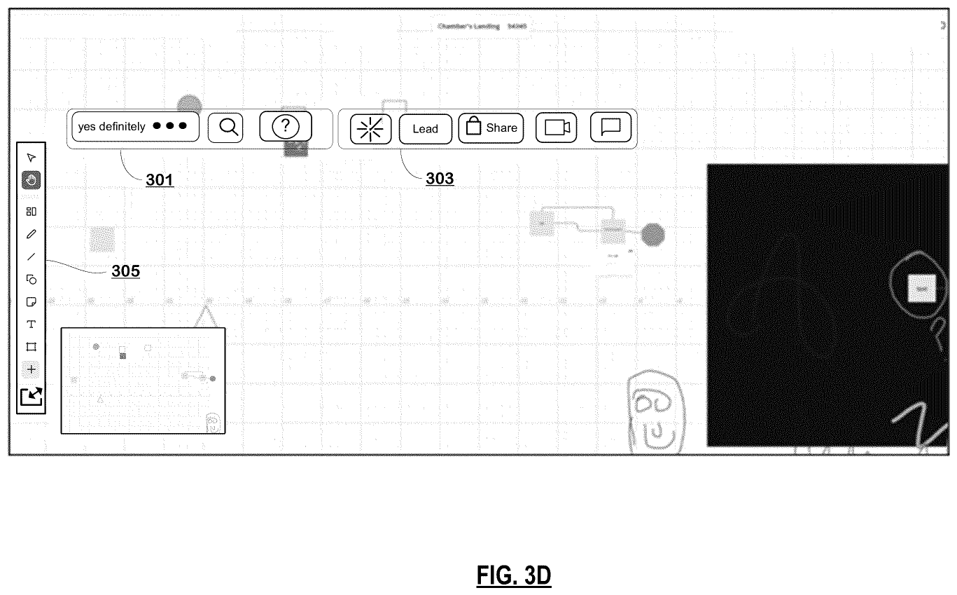

FIGS. 3A, 3B, 3C and 3D present a sequence of illustrations indicating triggering of the “summon toolbar” or “gather toolbar” functionality and resulting movement of the toolbar from an initial position near the top edge of the large format display to a destination or a target location that is closer to the user. The target location can be a location on the virtual workspace or collaboration workspace. This location can be represented as positions along horizontal and vertical coordinates in a two-dimensional workspace such as (x, y) values. In case of a three-dimensional workspace, the depth coordination or z-axis value can also be included when identifying a target location on the workspace. The target location can also be a location on the digital display. The location a digital display can be represented by a pixel number (or a group of pixels) or a pixel position (or a position of a group of pixels) with respect to a reference point (or points) such as the top-left corner, bottom-right corner, etc. of the digital display. FIG. 3A shows various tools in a toolbar are positioned in three different locations labeled as 301, 303 and 305 on a large format display 300. In some cases, the toolbar can be located in one location, however, the technology disclosed can summon tools from multiple different locations on the large format display. The tools at location 301 can be used for searching content in the workspace. This group of tools at location 301 can be referred to as a “search toolbar”. A user can enter search keywords in a text input box. Audio input can also be used by the user to provide search keywords. The tools at the location 303 include user interface elements to lead a collaboration session, share content with other users in the collaboration session (such as via an email or a text message), start a video conference with other users and send messages to other users using a chat feature. The tools at the location 303 can be referred to as a collaboration toolbar. The tools at the location 305 include various drawing and editing tools such as pens, colors, shapes, text, etc. The tools at the location 305 also include navigation tools to navigate the workspace such as by pan operation. A tool 307 can be selected to summon or gather the toolbars to a location closer to the position of the user. The tools at the 307 can be referred to as editing and navigation toolbar. The three groups of tools at locations 301, 303 and 305 can be considered as a single toolbar or three different toolbars. It is understood that the technology disclosed can include other tools and toolbars that are not shown in the example in FIG. 3A. A minified map 309 (also referred to as a “mini map”) of the workspace is also displayed on the digital display 300 in FIG. 3A. The minified map can include caricatures or small-sized images of digital assets displayed in a portion of the workspace. For example, the minified map can display caricatures of digital assets that are currently displayed on the digital display 300. In other implementations, the minified map can include additional digital assets that are currently not displayed on the digital display because they are outside the current viewport. When zoom-in or zoom-out operation are performed, the minified map can be updated to include or exclude the digital assets. Similarly, when a pan operation is performed, the minified map is updated to include the digital assets that are currently displayed on the digital display. The minified map can also display more or less of the collaboration workspace that is current displayed on the display. A user can control the amount of the entire collaboration workspace that is displayed in the minified map. The user can use the minified map to view a different portion of the collaboration workspace than what is currently displayed on the display and can further use the minified map to jump or navigate to other portions of the collaboration workspace. The technology disclosed can perform various operations such as summoning of the minified map to a location on the digital display that is closer to the position of the user. The user can interact with the minified map to quickly navigate to a portion of the workspace that may be physically away from the user's current location. The user may also select one or more digital assets in the minified map to zoom-in on the selected digital assets. The minified map can be displayed by selecting a user interface element or by performing a gesture. Similarly, the minified map can be removed from the digital display by selecting a user interface element or by performing a gesture.

FIG. 3B shows that a user selects a button (or a user interface element 307) to trigger the “summon toolbar” or “gather toolbar” functionality.

FIG. 3C shows that the tools 301 and 303 start moving towards the user's selected destination on the large format display and are positioned closer to the location of the summon toolbar user interface element 307 from where the user triggered the summon toolbar or gather toolbar functionality.

FIG. 3D shows that the toolbar is positioned close to the button 307. The user can now easily access all button (or user interface elements) in the toolbar as these are now located close to the user's position.

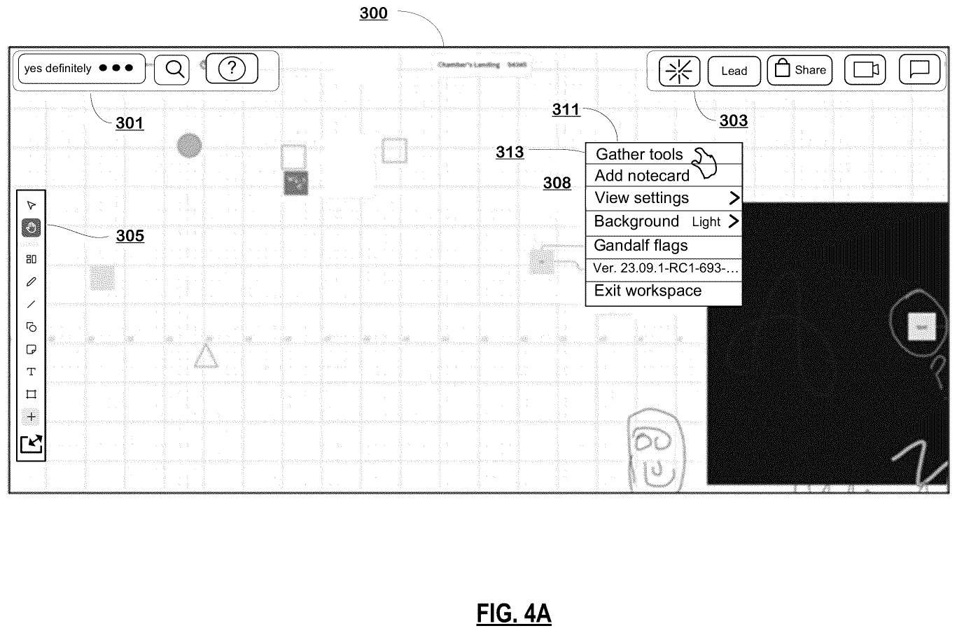

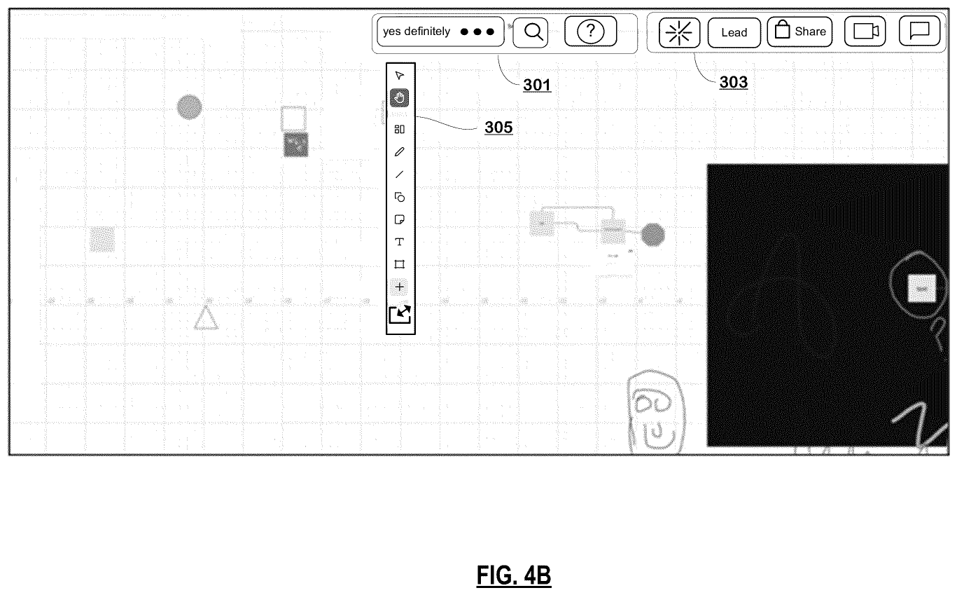

FIGS. 4A and 4B present another example in which the toolbar is summoned to a location on the large format display that is close to the position of the user. However, in this example, the summon toolbar or gather toolbar functionality is triggered using an input or a gesture at a location 308 on the large format display 300. The input or the gesture causes a menu 311 to display on the large format display. The user then selects a menu option 313 to summon toolbar or gather toolbar. FIG. 4B shows that the toolbars 301, 303 and 305 gather close to the location 308 from where the user triggered the “summon toolbar” or “gather toolbar” functionality. When the user presses on the touch-enabled large format interactive display and continues to press for a specified amount of time, the user gets feedback from the system that the system is processing the function to summon or gather the tool bar from a remote location to the current location at which the touch has occurred. The toolbar then shows up at the location at which the touch has occurred. The system can also display a menu (such as menu 311) and get an input from the user to summon the toolbar to the current location from which the user can select a gather toolbar or summon tool bar menu item and move the toolbar from a remote location on the digital display to the current location. In one implementation the toolbar at the remote location can collapse and move to the destination or the current location in a compact form. At the destination location, the toolbar appears in a compact form. After using the tools from the toolbar, the user can send the toolbar back to its original location (i.e., at the top, right or left side of the display) by selecting a user interface element on the collapsed toolbar or performing a gesture such as a double click, double touch, etc. The user can also summon the toolbar to a new location on the large format display from a current location.

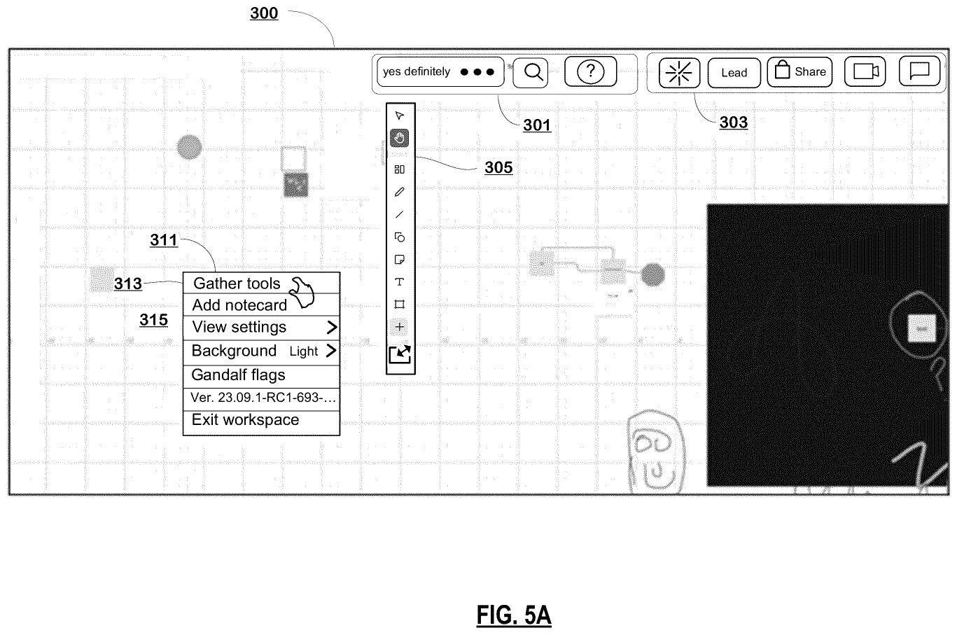

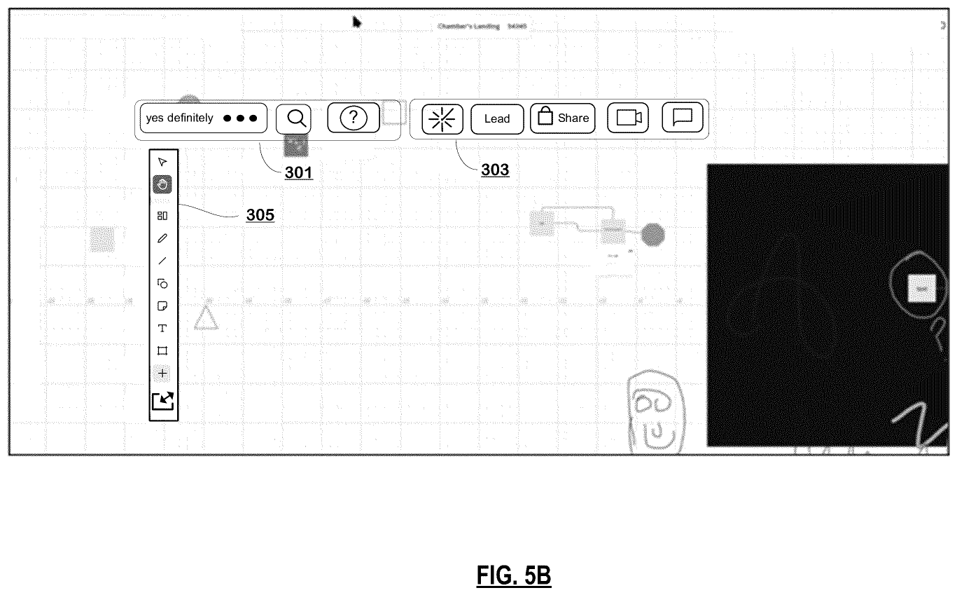

FIGS. 5A and 5B present another example in which the user triggers summon toolbar or gather toolbar functionality from a location 315 on the large format display 300. The user provides a gesture or input at the location 315 which cause the collaboration system to display the menu 311 at (or near) the location 315 on the large format display. The user then selects the menu item 313 to trigger the gather toolbar or summon toolbar functionality. Note that the toolbar (comprising three toolbars, sub-toolbars or components 301, 303 and 305) is arranged in the top right portion of the large format display. After the user selects the menu item 313, the toolbar moves to a destination location that is closer to the location 315 from where the user triggered the summon toolbar or gather toolbar functionality. The new location of the toolbar is shown in FIG. 5B.

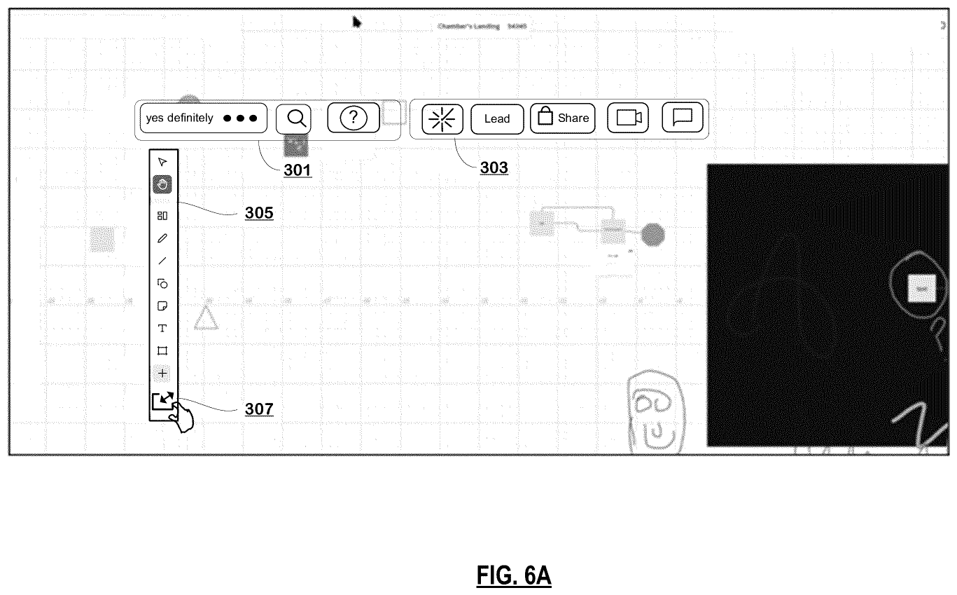

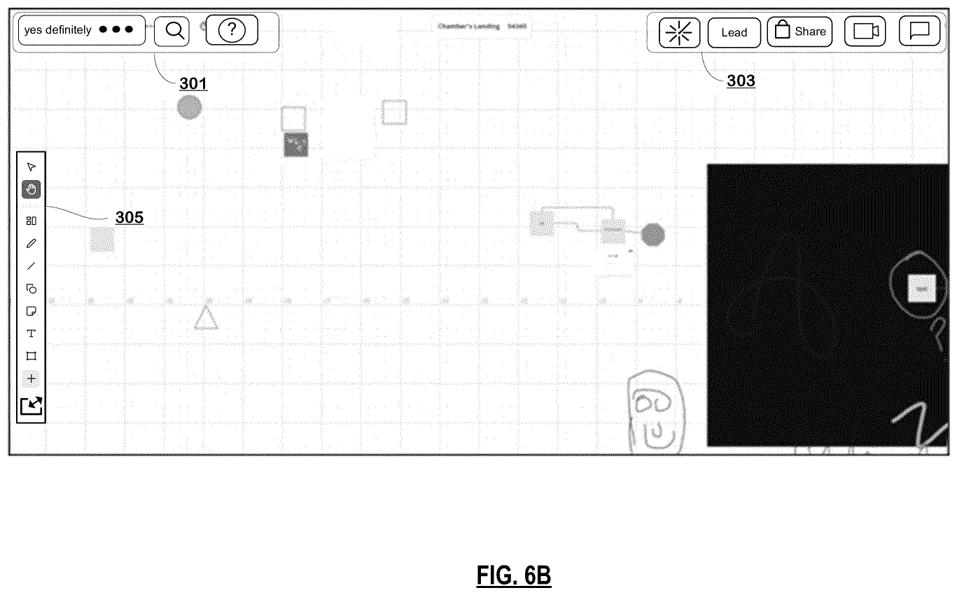

FIGS. 6A and 6B present an illustration in which the toolbar is moved back to its original location after the user has used the tools in the toolbar at the current location on the digital display. FIG. 6A shows the location of the toolbar (301, 303 and 305) that is closer to the position of the user. After using the toolbar, the user selects a button (or a user interface clement) 307 that initiates the logic that causes the toolbar to move to its original position on the larger format display as referred by labels 301, 303 and 305 in FIG. 6B.

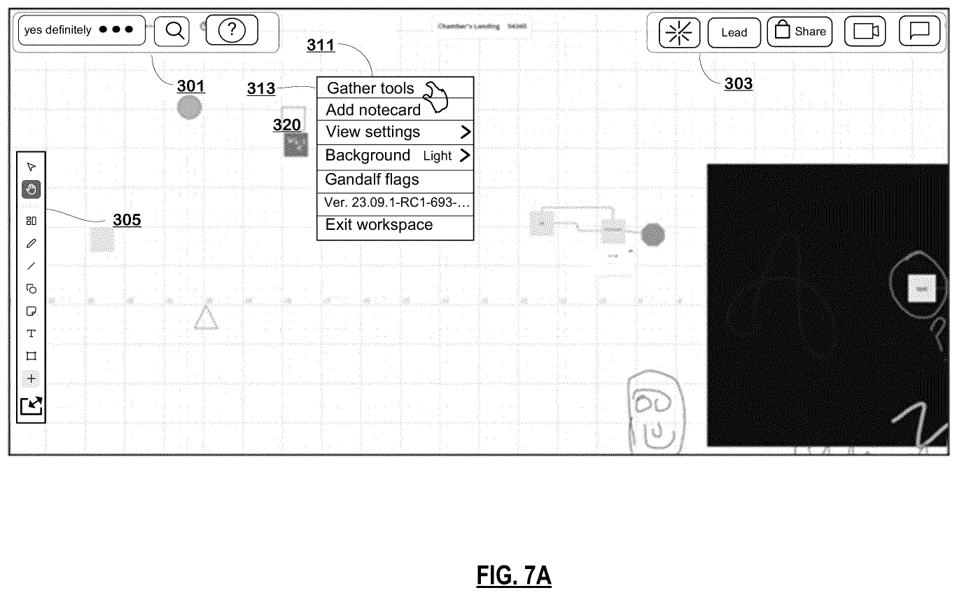

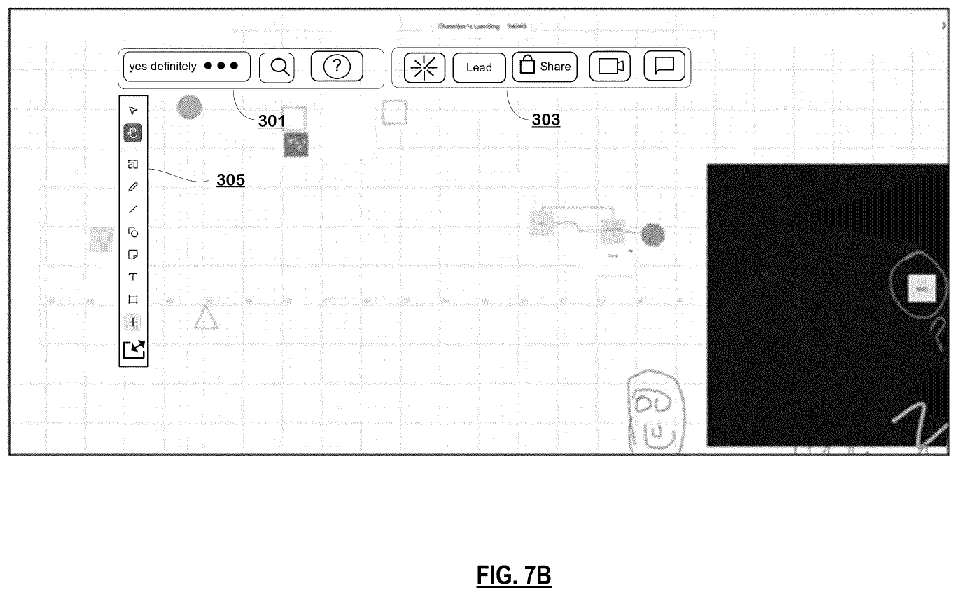

FIGS. 7A and 7B present an illustration in which a user selects a menu item in a menu to summon the toolbar to a location 320 on the large format display. The input can be provided by pressing or touching the touch-enabled large format display at the location 320. When the user presses on the interactive display and continues to press for a specified amount of time, the user gets feedback from the system that the collaboration system is processing the function to summon or gather the tool bar from a remote location to the current location at which the touch or gesture has occurred. The toolbar is then moved to the location close to the location 320 at which the user provided input or performed the gesture. Other types of inputs or gestures can also be provided such as mouse click, touch gestures such as double click, triple click, long press, etc. A mouse click or input by pressing a button a keyboard can be provided when the large screen display is not touch-enabled or when the user is positioned away from the large format display can prefers to provide the input via a tracking device or a keyboard. In another implementation, the menu 311 is displayed when the user provides the input or the gesture. The user can then select the menu item 313 to trigger the summon toolbar or gather toolbar functionality.

FIG. 7B show the toolbars after they have moved from their original location to the target or destination location close to the location 320.

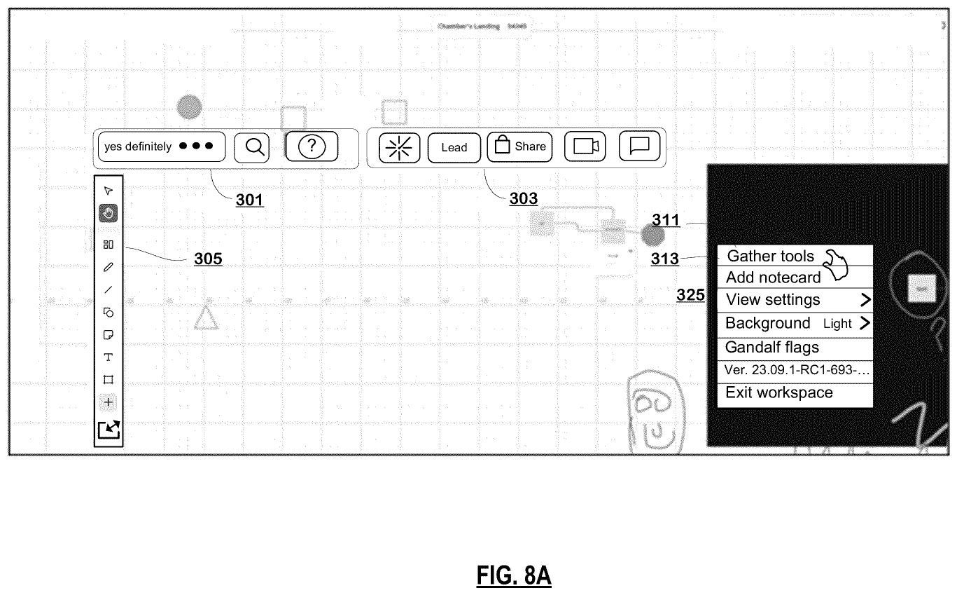

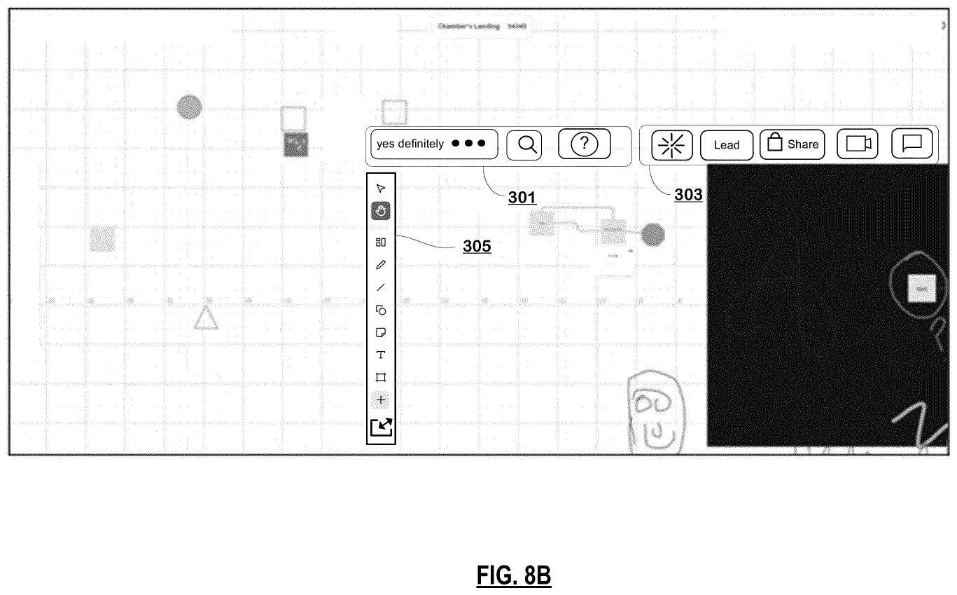

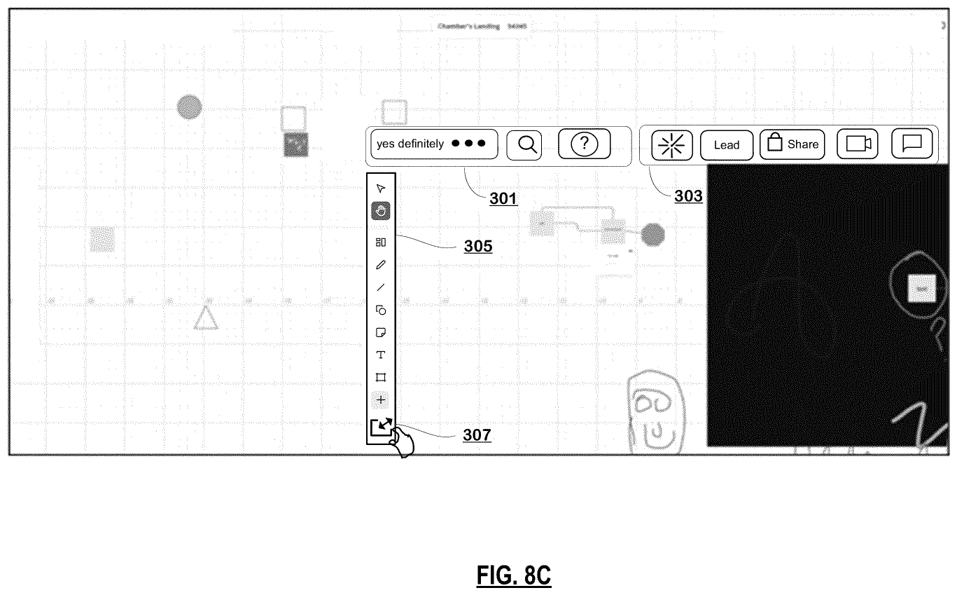

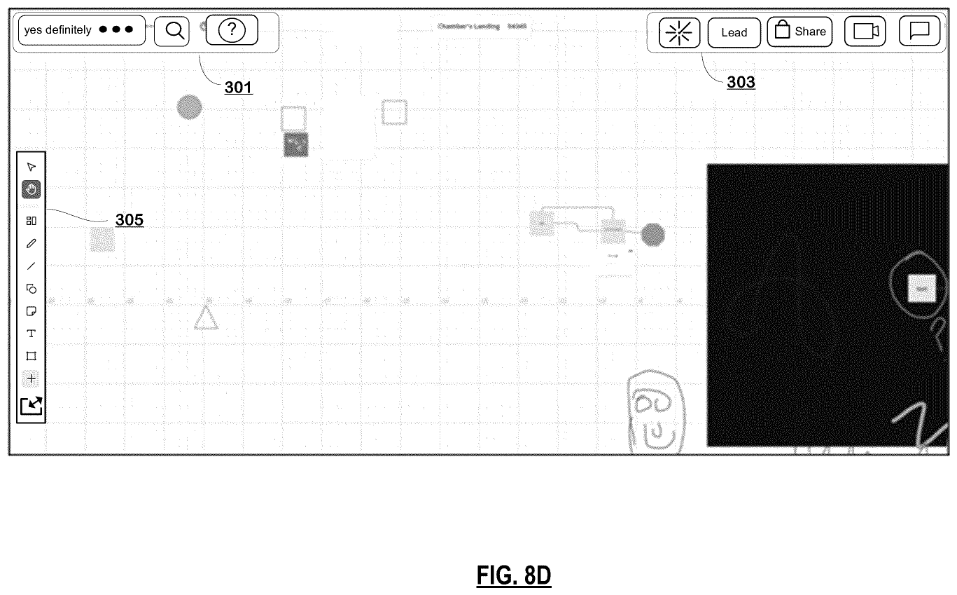

FIGS. 8A, 8B, 8C and 8D present an illustration in which the user summons the toolbar (301, 303, 305) which is located in the left portion of the large format display. The user summons the toolbar from a location 325 in a right portion of the large format display. When the user selects the menu item 313 as shown in FIG. 8A, the toolbar (301, 303, 305) moves to a right portion of the large format display at a destination location closer to the location 325 from where the user triggered the summon toolbar or gather toolbar functionality. The new location of the toolbar after moving to the destination is shown in FIG. 8B. After working with the tools in the toolbar, the user can select a user interface element 307, as shown in FIG. 8C, to send the toolbar (301, 303, 305) to a location that is near (or at) the original location near the top edge and the left edge of the large format display as shown in a FIG. 8D.

The technology disclosed includes logic to use other inputs such as video feeds and images captured by one or more cameras or other types of sensors to determine a location of the user who is working on the digital display. The technology disclosed can then automatically summon the toolbar to or near a location close to the position of the user so that the user can access the user interface elements on the toolbar. The technology disclosed includes logic to track the user as the user works on content displayed on the digital display. When it is determined that the user has moved to a new location, the technology disclosed can move the toolbar to a location closer to the new location of the user. This can be used to track movement of a user or multiple users interacting with a large size display or combination of displays that are so large that users can walk to various locations to point to or interact with different portions of the display(s). The summons and gather techniques (as well as any other technique described herein) can be implemented when there are multiple users so that each user can have a respective toolbar or minified map at or near their locations with respect to the display(s). This can be accomplished using the logic, video feeds or other image capturing techniques mentioned above. Further, the summons and gather techniques (as well as any other technique described herein) can be implemented so that the toolbar and/or minified map can jump between the location of a first user or a second user, based on which user is designated as a leader. For example, if user A is the leader at a certain period of time, the toolbar and/or minified map will follow the location of user A as user A moves, but at another period of time user B is designated as the leader, so the toolbar and/or minified map can then follow the location of user B as user B moves. This can be done for both or one of the toolbar and the minified map (or any other object or component described herein), such that, for example, the toolbar will follow user A and the minified map will follow user B. This can be done for more than just two users and can also be done for any object or item described herein.

### Summoning Digital Assets in a Collaboration Session

The technology disclosed allows users to summon digital assets (or any type of content) from a source location on a large format display to a target (or destination) location on the large format display. When using a large format display, the digital assets or content at a height of five feet to five feet eight inches can be considered as easily accessible for users of an average height. This region is also referred to as a “hot zone”, where most of the user interaction occurs. For users with different heights, i.e., having above-average or below-average heights, the location of the hot zone on a large format display can change. Further, users with accessibility issues (such as disabilities, or on wheelchairs) may not be able to access the digital assets on a large format display that are farther away from them. The technology disclosed includes logic to summon or gather the digital assets closer to a user such as in a so-called “hot zone” from where the user can easily interact with the digital assets during the collaboration session.

Consider a collaboration session that is conducted in a leader-follower scenario. In this case, the positioning of the digital assets on the display of a leader may be different from the positioning of digital assets on the display linked to the computing device of the follower. As the leader interacts with the digital assets on the large format display, the digital assets that are farther away from the leader are pulled closer to the position of the leader based on the location of the leader with respect to the large format display. However, the follower may not notice this change because the follower is just following the leader and may not be interacting with the digital assets on the workspace. When the follower becomes a leader and starts interacting with the digital assets then the arrangement of the digital assets or content on the user's large format display may be updated if required. Therefore, the viewport of various users participating in the collaboration session can change based on the rearrangement of digital assets to provide users better accessibility to digital content. As the viewports of digital displays linked to client-side computing devices of participants are updated, the respective client-side computing devices send events to the server-side computing device including updates to their respective viewports.

The user can trigger a “summon content” or “gather content” functionality by providing an input using a user interface element or a button on the toolbar provided by the collaboration system. The user can also trigger the “summon content” or “gather content” functionality by performing a gesture such as a left swipe touch gesture or a right swipe touch gesture, or an up or a down swipe touch gestures, a long touch, a two-finger touch, a double or a triple touch gesture or other types of gestures. The user can trigger the “summon content” or “gather content” functionality by providing a hand wave gesture or voice command, etc. Furthermore, the “summon content” or “gather content” functionality can be triggered by detected movement of the user (e.g., walking from a left portion of the large display to a right portion of the large display, etc.).

In one implementation, the technology disclosed presents a minified map of the workspace to the user on the digital display close to the position of the user. For example, when the user triggers the summon toolbar or gather toolbar functionality, the technology disclosed presents the minified map of the workspace at a location close to the position at which the toolbar is placed so that the user can easily interact with the minified map (or mini map). The minified map can display representations or caricatures of digital assets or display low resolution images of digital assets. The user can select one or more digital assets from the minified map. The collaboration system then pans the workspace (or the digital whiteboard) to display the selected digital assets close to the location of the user. The minified map can also include representations of different regions of the workspace such as four quadrants or even eight or more partitions of the workspace. The user can select a region from the minified map to trigger the summon content or gather content functionality. The selected region is displayed closer to the user so that the user can easily interaction with the digital assets in the selected region. The minified map of the workspace or the digital whiteboard is also referred to as a “control view” of the collaboration session. The control view allows the user to control the viewport of the large format display. The user can select a portion of the workspace from the control view. The user interface of the minified view (or control view or minified map) can present a magnified view of digital assets in various parts of the workspace as the user hovers a pointer (such as a mouse or other types of tracking devices) over the minified map or the user touches various parts of the minified map. The user can finally select one part of the workspace from the minified map. That part of the workspace will then be displayed in the viewport of the user. The minified map can be summoned to different locations on the digital display. The user can select a user interface element or perform a gesture to summon the minified map to or near a location on the digital display. The technology disclosed includes logic to automatically summon the minified map to or near a location on the digital display at which a user is currently working. The technology disclosed can use other inputs from the user such as a voice command to move the minified map to a desired location on the digital display. The technology disclosed can use inputs from other devices such as a video feed from one or more cameras and/or image sensors to determine a location of the user with respect to the digital display. The technology disclosed can then automatically reposition the minified map to a location on the digital display that is close to the position of the user so that the user can easily access the minified map. The technology disclosed includes logic to hide the minified map upon selection of a user interface element or upon receiving a voice command from the user. The minified map is displayed again when the user selects a user interface element or provides a voice command to display the minified map.

The viewport to the workspace can be updated and the large format display can display the selected portion of the workspace, closer to the user. The change to the viewport is stored in the spatial event map which now stores the updated viewport for the user. The spatial event map contains data regarding digital assets such their respective locations in the workspace (or the digital whiteboard) and operations performed by the users on digital assets. Therefore, the technology disclosed creates an abstraction layer on top of the spatial event map. The technology disclosed uses the information from the spatial event map to generate a control view of the workspace (or the digital whiteboard) and display the control view closer to the position of the user. The technology disclosed updates the spatial event map using any changes to the workspace including the digital assets. The updates to the spatial event map are propagated by the collaboration server to the client-side computing devices of users participating in the collaboration session. Collaboration data (that is transmitted between server and client-side network nodes) including the spatial event map can include information regarding the user, such as user preferences regarding “summon content” or “gather content” functionality.

The above-described technology provides users the ability to easily interact with workspaces using large format displays without performing numerous pan and zoom operations to access the desired content. Therefore, the technology disclosed makes the collaboration system easily accessible for users with all kinds of heights and accessibility requirements. The technology disclosed therefore provides an accessibility model for collaboration sessions in which large format displays are used by one or more participants. The spatial event map can be utilized to track, store and transmit the locations of any of the elements described herein, including the toolbar and the minified map.

### Computer System

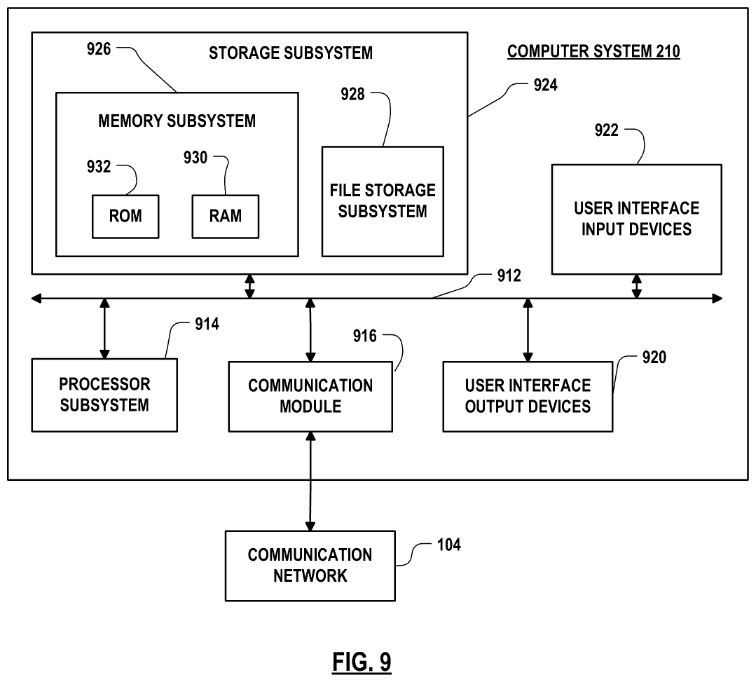

FIG. 9 is a simplified block diagram of a computer system, or network node, which can be used to implement the client functions (e.g., computer system 210) or the server-side functions (e.g., server 205) for summoning or gathering of a toolbar and/or digital assets. A computer system typically includes a processor subsystem 914 which communicates with a number of peripheral devices via bus subsystem 912. These peripheral devices may include a storage subsystem 924, comprising a memory subsystem 926 and a file storage subsystem 928, user interface input devices 922, user interface output devices 920, and a communication module 916. The input and output devices allow user interaction with the computer system. Communication module 916 provides physical and communication protocol support for interfaces to outside networks, including an interface to communication network 204, and is coupled via communication network 204 to corresponding communication modules in other computer systems. Communication network 204 may comprise many interconnected computer systems and communication links. These communication links may be wireline links, optical links, wireless links, or any other mechanisms for communication of information, but typically it is an IP-based communication network, at least at its extremities. While in one embodiment, communication network 204 is the Internet, in other embodiments, communication network 204 may be any suitable computer network.

The physical hardware component of network interfaces is sometimes referred to as network interface cards (NICs), although they need not be in the form of cards: for instance, they could be in the form of integrated circuits (ICs) and connectors fitted directly onto a motherboard, or in the form of macrocells fabricated on a single integrated circuit chip with other components of the computer system.

User interface input devices 922 may include a keyboard, pointing devices such as a mouse, trackball, touchpad, or graphics tablet, a scanner, a touch screen incorporated into the display (including the touch sensitive portions of large format digital display such as 102c), audio input devices such as voice recognition systems, microphones, and other types of tangible input devices. In general, use of the term “input device” is intended to include all possible types of devices and ways to input information into the computer system or onto computer network 104.

User interface output devices 920 may include a display subsystem, a printer, a fax machine, or non-visual displays such as audio output devices. The display subsystem may include a cathode ray tube (CRT), a flat panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from the computer system to the user or to another machine or computer system.

Storage subsystem 924 stores the basic programming and data constructs that provide the functionality of certain embodiments of the present invention.

The storage subsystem 924 when used for implementation of server nodes, comprises a product including a non-transitory computer readable medium storing a machine-readable data structure including a spatial event map which locates events in a workspace, wherein the spatial event map includes a log of events, entries in the log having a location of a graphical target of the event in the workspace and a time. Also, the storage subsystem 924 comprises a product including executable instructions for performing the procedures described herein associated with the server node.

The storage subsystem 924 when used for implementation of client-nodes, comprises a product including a non-transitory computer readable medium storing a machine readable data structure including a spatial event map in the form of a cached copy as explained below, which locates events in a workspace, wherein the spatial event map includes a log of events, entries in the log having a location of a graphical target of the event in the workspace and a time. Also, the storage subsystem 924 comprises a product including executable instructions for performing the procedures described herein associated with the client node.

For example, the various modules implementing the functionality of certain embodiments of the invention may be stored in storage subsystem 924. These software modules are generally executed by processor subsystem 914.

Memory subsystem 926 typically includes a number of memories including a main random-access memory (RAM) 930 for storage of instructions and data during program execution and a read only memory (ROM) 932 in which fixed instructions are stored. File storage subsystem 928 provides persistent storage for program and data files, and may include a hard disk drive, a floppy disk drive along with associated removable media, a CD ROM drive, an optical drive, or removable media cartridges. The databases and modules implementing the functionality of certain embodiments of the invention may have been provided on a computer readable medium such as one or more CD-ROMs and may be stored by file storage subsystem 928. The host memory 926 contains, among other things, computer instructions which, when executed by the processor subsystem 914, cause the computer system to operate or perform functions as described herein. As used herein, processes and software that are said to run in or on the “host” or the “computer,” execute on the processor subsystem 914 in response to computer instructions and data in the host memory subsystem 926 including any other local or remote storage for such instructions and data.

Bus subsystem 912 provides a mechanism for letting the various components and subsystems of a computer system communicate with each other as intended. Although bus subsystem 912 is shown schematically as a single bus, alternative embodiments of the bus subsystem may use multiple busses.

The computer system 210 itself can be of varying types including a personal computer, a portable computer, a workstation, a computer terminal, a network computer, a television, a mainframe, a server farm, or any other data processing system or user device. In one embodiment, a computer system includes several computer systems, each controlling one of the tiles that make up the large format display such as 102c. Due to the ever-changing nature of computers and networks, the description of computer system 210 depicted in FIG. 9 is intended only as a specific example for purposes of illustrating the preferred embodiments of the present invention. Many other configurations of the computer system are possible having more or less components than the computer system depicted in FIG. 9. The same components and variations can also make up each of the other devices 102 in the collaboration environment of FIG. 1, as well as the collaboration server 205 and database 206 as shown in FIG. 2.

Certain information about the drawing regions active on the digital display 102c are stored in a database accessible to the computer system 210 of the display client. The database can take on many forms in different embodiments, including but not limited to a MongoDB database, an XML database, a relational database, or an object-oriented database.

The applicant hereby discloses in isolation each individual feature described herein and any combination of two or more such features, to the extent that such features or combinations are capable of being carried out based on the present specification as a whole in light of the common general knowledge of a person skilled in the art, irrespective of whether such features or combinations of features solve any problems disclosed herein, and without limitation to the scope of the claims. The applicant indicates that aspects of the present technology may consist of any such feature or combination of features. In view of the foregoing description, it will be evident to a person skilled in the art that various modifications may be made within the scope of the technology.

The foregoing description of preferred embodiments of the present technology has been provided for the purposes of illustration and description. It is not intended to be exhaustive or to limit the technology to the precise forms disclosed. Obviously, many modifications and variations will be apparent to practitioners skilled in this art. For example, though the displays described herein are of large format, small format displays can also be arranged to use multiple drawing regions, though multiple drawing regions are more useful for displays that are at least as large as 12 feet in width. In particular, and without limitation, any and all variations described, suggested by the Background section of this patent application or by the material incorporated by reference are specifically incorporated by reference into the description herein of embodiments of the technology. In addition, any and all variations described, suggested or incorporated by reference herein with respect to any one embodiment are also to be considered taught with respect to all other embodiments. The embodiments described herein were chosen and described in order to best explain the principles of the technology and its practical application, thereby enabling others skilled in the art to understand the technology for various embodiments and with various modifications as are suited to the particular use contemplated. It is intended that the scope of the technology be defined by the following claims and their equivalents.

What is claimed is:

1. A method of summoning a toolbar, the method comprising:
receiving, by a server device, data related to a collaboration workspace including a toolbar displayed, by a large format display of a client device, at a first location in the collaboration workspace displayed on the large format display, wherein the toolbar includes user interface elements for interacting with the collaboration workspace using the large format display,
determining, by the server device, a second location in the collaboration workspace using the received data, and
sending, by the server device, collaboration data causing the toolbar including the user interface elements to move to the second location in the collaboration workspace, and causing display of the toolbar including the user interface elements at the second location.

2. The method of claim 1, further including:
sending, by the server device, collaboration data causing the toolbar including the user interface elements to move to or near the second location in the collaboration workspace, and causing display of the toolbar including the user interface elements at a location that is at a distance of least ten pixels from the second location.

3. The method of claim 2, wherein the toolbar including the user interface elements is displayed at a location that is at a distance of least one inch from the second location.

4. The method of claim 1, further including:
receiving, by the server device, data related to the second location of the collaboration workspace, and
sending, by the server device, the collaboration data causing moving of the toolbar to or near the first location, and causing display of the toolbar at or near the first location.

5. The method of claim 1, further including:
sending, by the server device, the collaboration data causing display of a user interface element at or near the second location of the collaboration workspace in response to a first user input,
receiving, by the server device, a second user input indicating selection of the user interface element, and
sending, by the server device, the collaboration data causing moving of the toolbar to or near the second location, and causing display of the toolbar at or near the second location.

6. The method of claim 1, further including:
receiving, by the server device, data related to the second location of the collaboration workspace, and
sending, by the server device, the collaboration data causing collapsing of the toolbar to a compact form, the collapsed toolbar in the compact form being of a smaller display size than the toolbar and hiding at least one user interface element, causing moving of the collapsed toolbar to or near the second location and causing the display of the collapsed toolbar at or near the second location.

7. The method of claim 6, further including:
receiving, by the server device, data related to the second location of the collaboration workspace, and
sending, by the server device, the collaboration data causing expanding of the collapsed toolbar to display the toolbar, at the second location, to include at least one of the hidden user interface elements.

8. The method of claim 1, further including:
receiving, by the server device, a first input via a large format display displaying a collaboration workspace, wherein the collaboration workspace includes at least one digital asset, of a plurality of digital assets, positioned on a first location,
generating, by the server device, a minified map of the collaboration workspace, wherein the minified map includes a miniaturized representation the at least one digital asset of the plurality of digital assets,
determining, by the server device, a second location in the collaboration workspace using a location on the large format display on which the first input is received,
sending, by the server device, collaboration data causing display of the minified map on the large format display at the second location,
receiving, by the server device, a second input on the large format display, the second input selecting the miniaturized representation of the at least one digital asset in the minified map, and
sending, by the server device, collaboration data causing panning the collaboration workspace, such that the panning moves the at least one digital asset close to the location of the minified map on the large format display.

9. The method of claim 8, wherein the minified map includes partitions of the workspace, wherein at least one partition of the workspace comprises the at least one digital asset of the plurality of digital assets, and wherein the method further includes:
receiving, by the server device, the second input on the large format display, the second input selecting the at least one partition of the workspace comprising the at least one digital asset of the plurality of digital assets.

10. The method of claim 8, further including:
receiving, by the server device, a user input including a third location for summoning the minified map, and
sending, by the server device, collaboration data causing moving of the minified map to a location at or near the third location and causing display of the minified map at the location.

11. The method of claim 1, further including:
receiving, by the server device, user input including at least one digital asset to move to a third location,
sending, by the server device, collaboration data including an updated location of the at least one digital asset wherein the updated location is at or near the third location and causing the display of the at least one digital asset at or near the third location.

12. A system including one or more processors coupled to memory, the memory loaded with computer instructions to summon a toolbar, the instructions, when executed on the processors, implement, at a server device, actions comprising:
receiving, by the server device, data related to a collaboration workspace including a toolbar displayed, by a large format display of a client device, at a first location in the collaboration workspace displayed on the large format display, wherein the toolbar includes user interface elements for interacting with the collaboration workspace using the large format display,
determining, by the server device, a second location in the collaboration workspace using the received data, and
sending, by the server device, collaboration data causing the toolbar including the user interface elements to move to the second location in the collaboration workspace, and causing display of the toolbar including the user interface elements at the second location.

13. The system of claim 12, further implementing actions comprising:
sending, by the server device, collaboration data causing the toolbar including the user interface elements to move to or near the second location in the collaboration workspace, and causing display of the toolbar including the user interface elements at a location that is at a distance of least ten pixels from the second location.

14. The system of claim 12, wherein the toolbar including the user interface elements is displayed at a location that is at a distance of least one inch from the second location.

15. The system of claim 12, further implementing actions comprising:
receiving, by the server device, data related to the second location of the collaboration workspace, and
sending, by the server device, the collaboration data causing moving of the toolbar to or near the first location, and causing display of the toolbar at or near the first location.

16. The system of claim 12, further implementing actions comprising:
receiving, by the server device, a first input via a large format display displaying a collaboration workspace, wherein the collaboration workspace includes at least one digital asset, of a plurality of digital assets, positioned on a first location,
generating, by the server device, a minified map of the collaboration workspace, wherein the minified map includes a miniaturized representation the at least one digital asset of the plurality of digital assets,
determining, by the server device, a second location in the collaboration workspace using a location on the large format display on which the first input is received,
sending, by the server device, collaboration data causing display of the minified map on the large format display at the second location,
receiving, by the server device, a second input on the large format display, the second input selecting the miniaturized representation of the at least one digital asset in the minified map, and
sending, by the server device, collaboration data allowing panning the collaboration workspace, such that the panning moves the at least one digital asset close to the location of the minified map on the large format display.

17. A non-transitory computer readable storage medium impressed with computer program instructions to summon a toolbar, the instructions, when executed on a processor, implement a method, of a server node, comprising:
receiving, by a server device, data related to a collaboration workspace including a toolbar displayed, by a large format display of a client device, at a first location in the collaboration workspace displayed on the large format display, wherein the toolbar includes user interface elements for interacting with the collaboration workspace using the large format display,
determining, by the server device, a second location in the collaboration workspace using the received data, and
sending, by the server device, collaboration data causing the toolbar including the user interface elements to move to the second location in the collaboration workspace, and causing display of the toolbar including the user interface elements at the second location.

18. The non-transitory computer readable storage medium of claim 17, implementing the method further comprising:
sending, by the server device, collaboration data causing the toolbar including the user interface elements to move to or near the second location in the collaboration workspace, and causing display of the toolbar including the user interface elements at a location that is at a distance of least ten pixels from the second location.

19. The non-transitory computer readable storage medium of claim 17, wherein the toolbar including the user interface elements is displayed at a location that is at a distance of least one inch from the second location.

20. The non-transitory computer readable storage medium of claim 17, implementing the method further comprising:
receiving, by the server device, data related to the second location of the collaboration workspace, and
sending, by the server device, the collaboration data causing moving of the toolbar to or near the first location, and causing display of the toolbar at or near the first location.
